(19) United States
(12) Patent Application Publication
(10) Pub. No.: US 2006/0110545 A1
(43) Pub. Date: May 25, 2006

(54) Method of forming conductive pattern

(75) Inventor: Naoyuki Toyoda, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/256,605

(22) Filed: Oct. 21, 2005

(30) Foreign Application Priority Data
Nov. 25, 2004 (JP) 2004-339907

(51) Int. Cl. G21H 5/00; B05D 3/00; C08J 7/18; B32B 3/10

(52) U.S. Cl. 427/554; 428/131

(57) ABSTRACT

A method of forming a conductive pattern includes a step of forming a bank on a substrate and a step of applying a lyophobic agent to a part or whole of an upper face of the bank.

### BACKGROUND OF THE INVENTION

1. Technical Field

The present invention relates to a process of manufacturing a metal wiring by an ink-jet method.

2. Related Art

JP-A-2002-305077 is an example of related art. As described in the example, a pattern of a partition wall member (hereinafter called a bank) which is a convexity formed on a substrate has been miniaturized by employing the ink-jet method. The bank has a lyophobic quality and the substrate has a lyophilic quality so that a conductive material liquid (hereinafter called an ink) discharged by the ink-jet method can settle in a concave portion (hereinafter called a bank groove part) which is formed by the bank and the substrate, and this can prevent the ink from flowing out of the bank.

In a case of forming a conductive pattern through which a relatively large current passes, the pattern should be formed so as to have a certain thickness in order to reduce an electric resistance of the pattern. However, because of the lyophobic quality of the bank, only a limited amount of the ink could be held in the concave portion that is formed by the bank and the substrate. Therefore, a sufficient thickness for the conductive pattern could not be secured and it was not appropriate as the conductive pattern though which a relatively large current passes.

When the ink discharged by the ink-jet method reaches the substrate, the size (hereinafter, called “a landing diameter”) of the landed ink mainly depends on a relation between viscosity of the ink and a surface tension of the substrate. If the concave portion whose width is smaller than the landing diameter is provided on the substrate, and the ink is then discharged so as to land on the concave portion, a part of the ink will remain on the top surface of the bank (hereinafter called “a landing mark”). The landing mark will go through a heat treatment and the like together with the remaining ink in the bank, and this treatment will give conductivity to the landing mark. Therefore, this became a problem impairing the electric credibility of the substrate.

### SUMMARY

An advantage of the invention is to provide a method of forming a conductive pattern. With the method, the conductive pattern can be easily formed so as to have a relatively large thickness and there is no landing mark even if the pattern has a smaller width than the landing diameter of the ink.

A method of forming a conductive pattern according to a first aspect of the invention includes a step of forming a bank on a substrate and a step of applying a lyophobic agent to a part or whole of an upper face of the bank.

According to the first aspect of the invention, the method includes the step of forming a bank on a substrate and the step of applying a lyophobic agent to a part or whole of an upper face of the bank. When the ink is discharged on the upper face of the bank by the ink-jet method, it can prevent the ink from remaining on the upper face of the bank with the lyophobic agent applied on a part or whole of an upper face of the bank. Accordingly, the conductive pattern that dose not have a landing mark on the bank upper face can be obtained.

A method of forming a conductive pattern according to a second aspect of the invention includes a step of forming a bank on a substrate, a step of giving a lyophilic quality to a part or whole of the substrate and the bank and a step of applying a lyophobic agent to a part or whole of an upper face of the bank.

According to the second aspect of the invention, it is possible to obtain a conductive pattern that dose not have a landing mark even if the width of the conductive pattern is smaller than a landing diameter of an ink.

In these cases, the lyophobic agent may be attached to an original plate member that is separately provided other than the substrate, and the lyophobic agent may be transferred to a part or whole of the upper face of the bank by contacting the original plate member with the upper face of the bank on the substrate.

Because the lyophobic agent is attached to the original plate member that is separately provided other than the substrate, and the lyophobic agent is transferred to a part or whole of the upper face of the bank by contacting the original plate member with the upper face of the bank on the substrate, it is possible to provide the lyophobic agent on a part or whole of the upper face of the bank without affecting a lyophilic bank groove.

It is preferable that the bank is formed by a photolithography method, a transfer method or a printing method.

In this way, a bank having a width smaller than the landing diameter of the ink can be formed.

It is also preferable that the bank is made of an organic or inorganic material.

In this way, the aspects of the invention can be applied regardless of the bank material.

Moreover, it is preferable that a height of the bank is equal to or more than 1 μm.

When the bank is higher than 1 μm, it can prevent the lyophobic agent from attaching in the bank groove when the lyophobic agent is applied to a part or whole of the upper face of the bank.

The process of giving the lyophilic quality to a part or whole of the substrate and the bank may include at least one of ozone oxidation treatment, plasma treatment, corona treatment, ultraviolet irradiation treatment, electron irradiation treatment, acid treatment and alkali treatment.

The lyophilic quality may be given to a part or whole of the substrate and the bank by at least one of ozone oxidation treatment, plasma treatment, corona treatment, ultraviolet irradiation treatment, electron irradiation treatment, acid treatment and alkali treatment.

It is preferable that the original plate member is in a form of a plate or a roll.

In this way, the lyophobic agent attached on the flat or rolled original plate member can be easily transferred to a part or whole of the bank upper face formed on the substrate, and the lyophobicity is given to the part or whole of the bank upper face.

Furthermore, it is also preferable that a material for the original plate member is an elastomer having a siloxane structure.

Since the material of the original plate member is the elastomer having at least the siloxane structure, the original plate member can have elasticity and adhesiveness between the substrate and a part or whole of the bank can be increased. Resistance to the lyophobic agent can also be secured.

It is preferable that the lyophobic agent is a silane coupling agent or a polymer having the lyophobic quality.

When the lyophobic agent is a silane coupling agent or a polymer having the lyophobic quality, a strong lyophobicity can be given to a part or whole of the bank upper face. Thereby, it is possible to stably store the ink in the bank groove part.

### BRIEF DESCRIPTION OF THE DRAWINGS

The invention will be described with reference to the accompanying drawings, wherein like numbers reference like elements.

FIG. 1 is a flow chart of a process of forming a substrate and a bank on the substrate.

FIGS. 2A though 2F are sectional views of the substrate showing a process of forming the bank by etching a bank film by a photolithography method.

FIGS. 3A and 3B are sectional views of the substrate showing a process of forming the bank by a transfer method.

FIGS. 4A though 4C are sectional views of the substrate showing a process of forming the bank by etching the bank film by a printing method.

FIG. 5 is a sectional view of the substrate explaining a process (S102, S103) of directly forming the bank by a printing method in the flow chart shown in FIG. 1.

FIGS. 6A though 6C are sectional views of the substrate showing a process of directly forming the bank by a printing method called an emboss method.

FIGS. 7A though 7C are sectional views of the substrate showing a process of directly forming the bank by a printing method called an imprint method.

FIGS. 8A though 8E are sectional views of the substrate explaining a process (S121, S124, S125) of forming the bank by etching the substrate by the photolithography method in the flow chart shown in FIG. 1.

FIGS. 9A though 9D are sectional views of the substrate explaining a process (S122, S124, S125) of forming the bank by etching the substrate by the transfer method in the flow chart shown in FIG. 1.

FIGS. 10A though 10C are sectional views of the substrate explaining a process (S123, S124, S125) of forming the bank by etching the substrate by the printing method in the flow chart shown in FIG. 1.

FIG. 11A is a plan view of an original plate member showing its fabrication process.

FIG. 11B is a sectional view of the original plate member along the line A-A in FIG. 11A.

FIG. 11C is a perspective view of the completed original plate member.

FIG. 12A is a sectional view of an original plate member 51 on which a lyophobic agent 80 is applied.

FIG. 12B is a sectional view of a substrate 10 and the original plate 51 explaining a process of transferring the lyophobic agent 80 on the original plate surface 54a to the bank upper face 12e of the substrate 10 by contacting a original plate surface 54a on which the lyophobic agent 80 is applied with a bank upper face 12e of the substrate 10.

FIG. 12C is a sectional view of the substrate 10 showing that the original plate member 51 is separated from the bank upper face 12e of the substrate 10 and the lyophobic agent 80 is transferred on the bank upper face 12e of the substrate 10.

FIG. 13A is a sectional perspective view of a droplet discharge head 200.

FIG. 13B is a detailed sectional view of a discharge part.

FIGS. 14A through 14C are sectional views explaining a relation between the substrate 10 and a conductive liquid material 11 discharged from the droplet discharge head 200.

FIGS. 15A and 15B are plan sectional views showing a process of forming a rolled original plate member 61.

FIG. 15C is a perspective view of the rolled original plate member 61 taken out from a mold form 62.

FIG. 16 is a sectional view of the substrate showing a process of applying the lyophobic agent 80 onto the bank upper face 12e of a necessary bank film 12a while forming the bank by the emboss printing method.

FIG. 17A is a partial plan view of the substrate showing a method of providing a gate electrode for mounting a TFT and FIG. 17B is a corresponding partial sectional view of the substrate.

### DESCRIPTION OF THE EMBODIMENTS

### First Embodiment

A first embodiment of the invention describes a process of forming a substrate and a bank on the substrate to which a method of forming a conductive pattern is applied, a process of giving lyophilicity to the substrate and a part or whole of bank, and a process of applying a lyophobic agent to a part or whole of an upper face of the bank.

Flowchart of Process of Forming Substrate and Bank on the Substrate

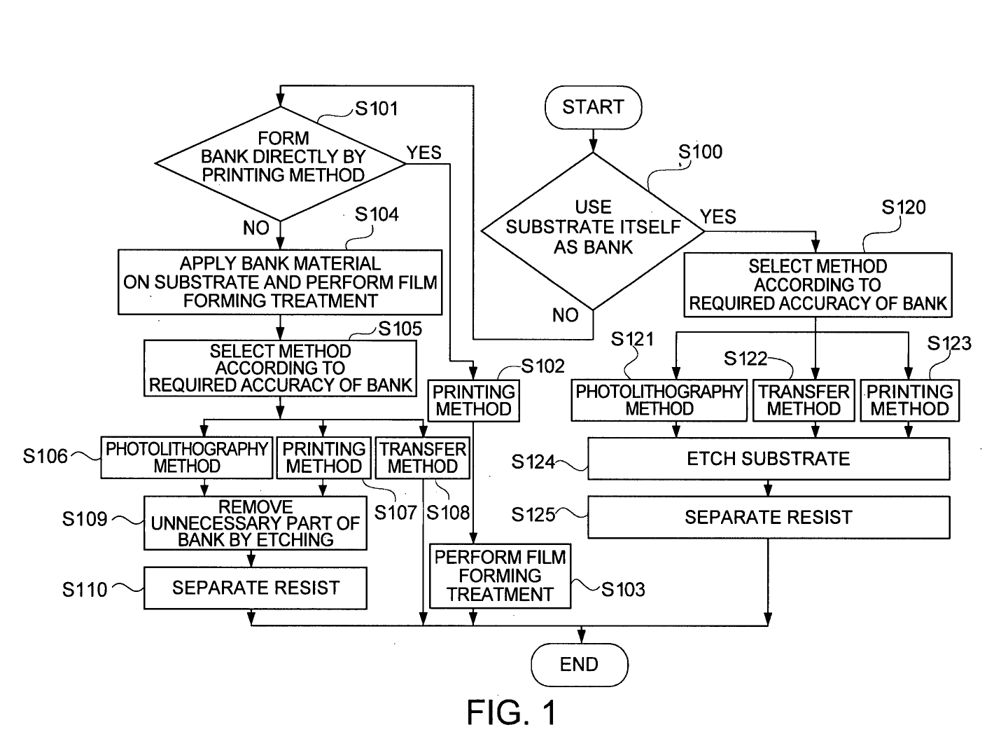

FIG. 1 is a flow chart of a process of forming a substrate and a bank on the substrate. In this embodiment, whether the substrate itself is used as the bank or not will be chosen in Step (hereinafter denote as “S”) 100. When the substrate is not used as the bank, go to S101. When the substrate itself is used as the bank, go to S120.

As for the substrate, the following material can be used; transparent or translucent inorganic substrate materials such as glass and silica, monocrystal or non-monocrystal semiconductor substrate materials such as diamond, silicon series and germanium series, other substrate materials such as ceramic, general plastics such as polyethylene resin series, polystyrene resin series, polyethylene terephthalate resin series, polyacryl resin series and polymethacryl resin series, and engineering plastics such as polycarbonate resin series, polyester resin series, polyamide resin series, polyacetal resin series, polyamide-imide resin series, polyimide resin series, polyetherimide resin series, epoxy resin series (including glass contained one), polysulfone resin series, polyether sulfone resin series, polyether resin series, polyether ether ketone resin series, polyether nitrile resin series, polyphenylene ether resin series, polyphenylene sulfide resin series and polyphenol resin series. Either one of the above-mentioned material or more than one materials combined can be used for the substrate.

The case when the substrate is not used as the bank will be now described.

In Step 101 (S101), whether the bank is formed directly on the substrate by a printing method or not is selected. When the bank is decided to be formed directly on the substrate by the printing method, go to S102. When the bank is not formed directly on the substrate by the printing method, go to S104. According to the printing method in S102, a bank material is provided on the substrate in a desired pattern by any of the printing methods, such as screen printing method, offset printing method, emboss method and imprint method. The desired bank can be obtained by performing a film forming process including a heat and/or light treatment in S103. The heat and/or light treatment is a treatment in which the bank material is activated and reacted by heat or irradiation of ultraviolet, infrared, visible ray and the like, obtaining the feature of the bank. Hereinafter, this heat and/or light treatment is called a film forming treatment.

In S104, the bank material is applied or deposited on a part or whole of the substrate and then the film forming treatment for obtaining the feature as the bank is performed. The obtained film is hereinafter called a bank film. The thickness of the bank film, which is a height of the bank, is preferably equal to or larger than 1 μm.

When the substrate itself is not used as the bank, the bank material applied or deposited on the substrate is inorganic materials such as the inorganic substrate material, the semiconductor substrate material and a ceramic substrate material or organic materials such as the general plastics and the engineering plastics. Either one of the above-mentioned material or more than one materials combined can be used for the material.

A method of applying or depositing the material is further described.

As the method of applying the material, there are a spin-coat method, a spray-coat method, a roll-coat method, a die-coat method and a dip-coat method. In the spin-coat method, the above-mentioned liquid bank material is supplied to a spinning substrate and a bank film having a desired thickness can be obtained. In the spray coat method, the above-mentioned liquid bank material is transformed in a mist form by using a gas or a medium and the bank material in the form of mist is sprayed on the substrate. In the roll-coat method, the above-mentioned liquid bank material is provided on a plurality of spinning rolls and the material is arranged in a predetermined thickness. The bank material is then transferred from the roll to the substrate by contacting a substrate to at least one of the rolls. In the die-coat method, the above-mentioned liquid bank material is supplied in a squeegee and the material is evenly applied to a substrate from the edge of the squeegee. In the dip-coat method, the above-mentioned liquid bank material is stored in a container and the material is applied by dipping a substrate in the material and then lifting the substrate from the material at a constant speed.

As a method of forming the bank film obtained in S104 shown in the figure into a desired pattern, there are a photolithography method, a transfer method and a printing method. The method is selected depending on accuracy of the bank which is required in S105.

When the photolithography method in S106 is employed, a liquid resist is applied, exposed and developed as using a mask that is matched with the shape of the bank, and then an unnecessary part of the bank film is removed by etching in S109. The resist is separated in S110 and a bank having a desired shape can be obtained. The detail will hereinafter be described.

The transfer method in S108 is particularly appropriate for a case that the bank material mainly consists of an organic material. The bank material is deposited on a film in advance and a desired pattern is formed by the photolithography method or the printing method. A face of the film on which the bank is formed is opposed to a substrate and the substrate and the bank are bonded together by pressing them by a plurality of rollers. Then, the film is separated from the bank and only the bank is left on the substrate. In this way, the bank having a desired shape can be obtained. This method has a beneficial effect on a large size substrate. In addition, this method is low cost way compared to a case in which only the photolithography in S106 is used because it is not necessary to etch the bank and the bank can be obtained only with dry processes. The detail will hereinafter be described.

When the printing method in S107 is employed, there are the screen printing, the offset printing, the emboss printing and the imprinting method.

When the screen printing method or the offset printing method is used as the printing method in S107, the bank material is printed on a substrate by the screen printing or the offset printing using an original plate that has a desired pattern. The material printed on the substrate is hardened by drying, heating or light irradiation and the bank with the desired shape can be obtained. If the bank film is formed on a base, the unnecessary part of the bank film is removed by etching, the resist is removed in S110 and the bank with the desired shape can be obtained. This forming method is low cost compared to the photolithography method.

When the emboss method is used as the printing method in S107, the above-mentioned liquid bank material is provided on the substrate and once hardened by drying, heating or light irradiation. An original plate that has a desired pattern is attached and pressed to the substrate. The substrate is heated if necessary and the bank with the desired shape can be obtained. This method is low cost compared to the photolithography method.

When the imprinting method is used as the printing method in S107, the above-mentioned liquid bank material is provided on the substrate and the material is hardened by drying, heating or light irradiation while the original plate having a desired pattern is attached and pressed to the material. In this way, the bank with the desired pattern can be obtained. This method is low cost compared to the photolithography method in the same way as the emboss method.

Next, a case that the substrate itself is used as the bank is described.

In S100 in the figure, the case that the substrate itself is used as the bank is selected. In S120, one method is selected from the photolithography method, the transfer method and the printing method depending on a shape of the bank or accuracy of the position which is required in S120. The description of the photolithography method in S121, the transfer method in S122 and the printing method in S123 are omitted since they are the same as the above-described methods. A resist pattern is formed on a substrate by a corresponding method. A part of the substrate where the resist is not formed is etched by using an acidic solvent such as phosphoric acid, sulfuric acid and nitric acid or an alkaline solvent. Then, the resist is separated and a concave portion with a desired depth is formed in S125. This concave portion is used as a bank groove part.

Process of Forming Bank on Substrate by Photolithography Method.

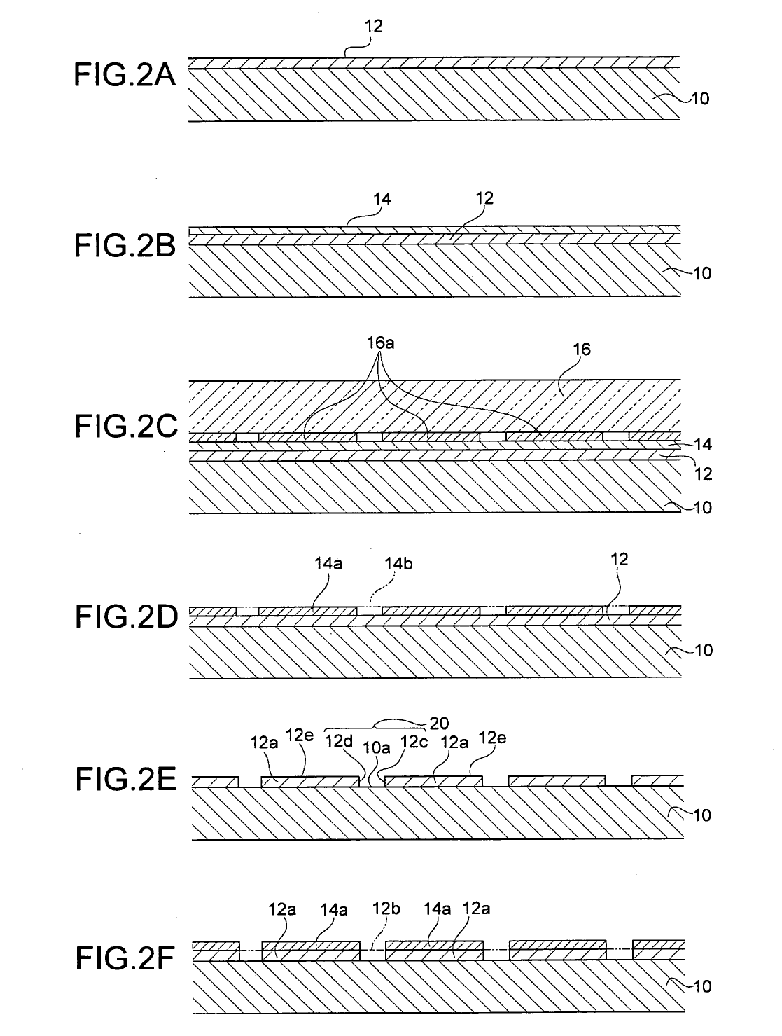

FIGS. 2A though 2F are sectional views of the substrate showing a process of forming the bank by etching the bank film by the photolithography method.

In FIG. 2A, a bank film 12 is formed on a part or whole of a substrate 10 in the way described in S104 in FIG. 1. In FIG. 2B, a resist 14 is formed on a part or whole of the bank film 12 shown in FIG. 2A in the way described in S106 in FIG. 1.

In FIG. 2C, a photomask 16 is provided so as to closely attach to the formed resist 14. A predetermined pattern is formed on a face of the photomask 16 to which the resist 14 is attached. A positive resist is used in this embodiment, and only a part where a photomask pattern 16a is not formed is irradiated with parallel light that is emitted from above the photomask 16.

In FIG. 2D, the resist 14 which is irradiated with the light is chemically reacted and becomes soluble in a developing agent. When the surface of the resist 14 is sufficiently dipped in the developing agent, an unnecessary resist 14b dissolves in the developing agent. On the contrary, a necessary resist 14a does not dissolve in the developing agent. The necessary resist 14a may be heated in order to increase adhesiveness to the bank film 12.

In FIG. 2E, a solvent (hereinafter called an etching solution) dissolving the bank film 12 is provided on the surface of the bank film 12, and an unnecessary bank film 12 where the necessary resist 14a does not exist is dissolved and removed. A necessary bank film 12a is secured between the necessary resist 14a and the substrate 10.

In FIG. 2F, the necessary resist 14a is removed by using a parting agent, and the necessary bank film 12a is formed in a pattern on the substrate 10. In this embodiment, a bank groove part 20 is a part formed of a bank wall side face 12c of one necessary bank film 12a, a bank wall side face 12d of the other necessary bank film 12a opposing the necessary bank film 12a and a surface 10a of the substrate 10. An upper face of the necessary bank film 12a is called a bank upper face 12e in this embodiment.

Process of Forming Bank on Substrate by Transfer Method

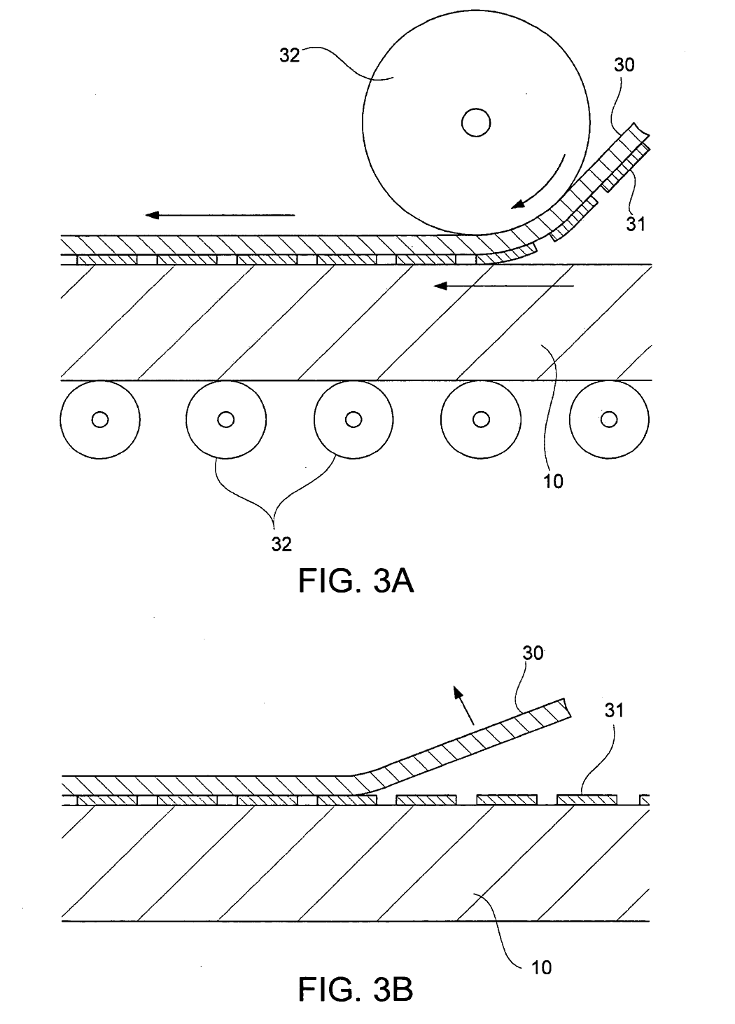

FIGS. 3A and 3B are sectional views of the substrate showing a process of forming the bank by the transfer method.

FIG. 3A is a sectional view of the substrate explaining a process of bonding the film on which the bank wall is formed and the substrate by pressure. A bank wall 31 made of an organic material is formed in a predetermined pattern on a film 30 in advance by the photolithography method or the printing method and the like. The film with the bank and the substrate opposing the face of the film on which the bank wall 31 is formed are put together between rollers. A distance between each roller 32 is adjusted. A plurality of the rollers 32 creates pressure among the film 30, the bank wall 31 and the substrate 10, and the bank wall 31 and the substrate 10 are bonded by the pressure. The roller or the air around the roller may be heated.

FIG. 3B is a sectional view of the substrate explaining a process of separating the film from the bonded bank wall. The adhesion between the film 30 and the bank wall 31 is smaller than the adhesion between the substrate 10 and the bank wall 31. Accordingly, when the film 30 is lifted, only the film 30 is separated while the bank wall 31 is still attached to the substrate 10. The material for the film 30 is not particularly limited as long as it has the enough adhesion such that the film 30 will not be separated from the bank wall 31 during the working process. Such material may be mainly fluorine series resin.

Process of Forming Bank on Substrate by Printing Method

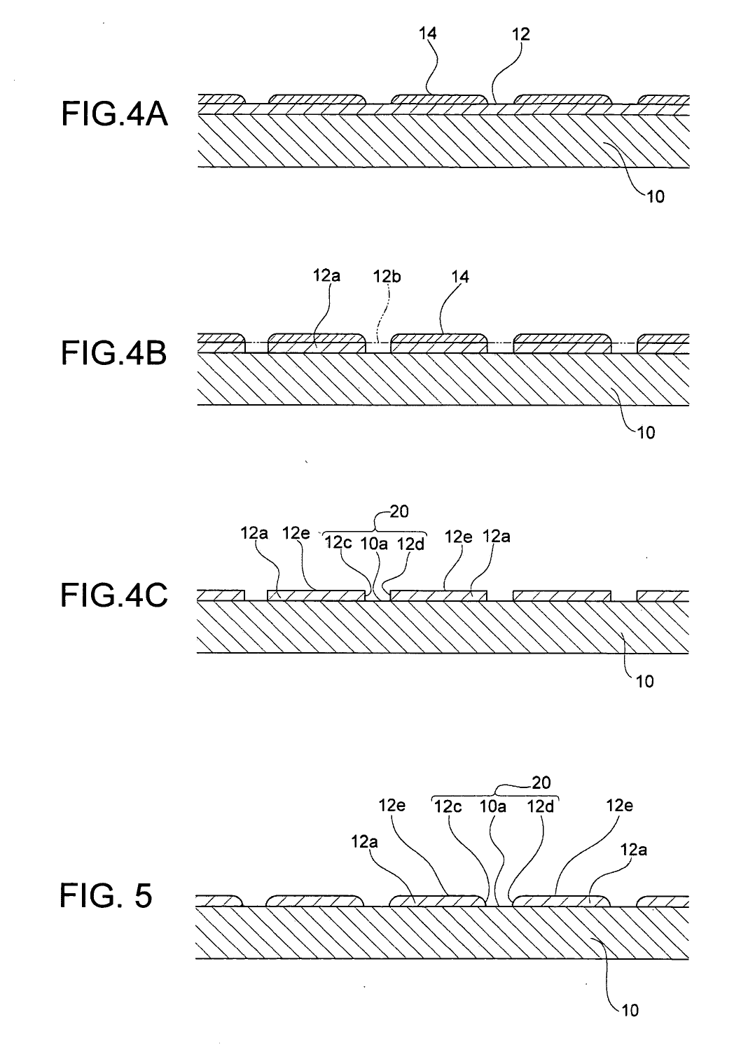

FIGS. 4A though 4C are sectional views of the substrate showing a process of forming the bank by etching the bank film by the screen printing method or the offset printing method.

In FIG. 4A, the bank film 12 is formed on the substrate 10 as described above. The resist 14 is printed in a desired pattern on the bank film 12 by the screen printing method or the offset printing method. The printed resist 14 and the substrate 10 are bonded together by heating, and the resist 14 is solidified. The resist 14 may be sensitive or insensitive to light. As the insensitive type of the resist, there is a coating medium and the like.

In FIG. 4B, a part where the resist 14 dose not exist (an unnecessary bank film 12b) is removed by etching. This etching is performed in the same way as the etching in the photolithography method.

In FIG. 4C, the resist 14 formed on the necessary bank film 12a is removed in the same way as the photolithography method. The necessary bank film 12a is formed in a desired pattern through the above-mentioned process. A concave portion that consists of the bank wall side face 12c of one necessary bank film 12a, the bank wall side face 12d of the other necessary bank film 12a opposing the necessary bank film 12a and the surface 10a of the substrate 10 is formed and this becomes the bank groove part 20. The upper face of the necessary bank film 12a is also called the bank upper face 12e in this embodiment.

Process of Forming Bank Directly on Substrate by Printing Method

FIG. 5 is a sectional view of the substrate for explaining a process (S102, S103) of directly forming the bank by the screen printing method or the offset printing method in the flow chart shown in FIG. 1.

In S102, the bank material is printed in a desired pattern on the substrate 10 by the screen printing method or the offset printing method and the necessary bank film 12a is obtained. In S103, the film forming treatment is performed and then the concave portion consisting of the bank wall side face 12c of one necessary bank film 12a, the bank wall side face 12d of the other necessary bank film 12a opposing the necessary bank film 12a and the surface 10a of the substrate 10 is formed. This concave portion becomes the bank groove part 20. The upper face of the necessary bank film 12a is also called the bank upper face 12e in this embodiment.

As compared to the bank wall side face 12c and the bank wall side face 12d formed by the etching, the wall side face 12c and the bank wall side face 12d directly formed on the substrate by this printing method has a slightly ambiguous border among the bank upper face 12e, the bank wall side face 12c and the bank wall side face 12d. However, this method has an advantage that the processes till the bank groove part 20 is formed can be short.

Process of Forming Bank Directly on Substrate by Printing Method

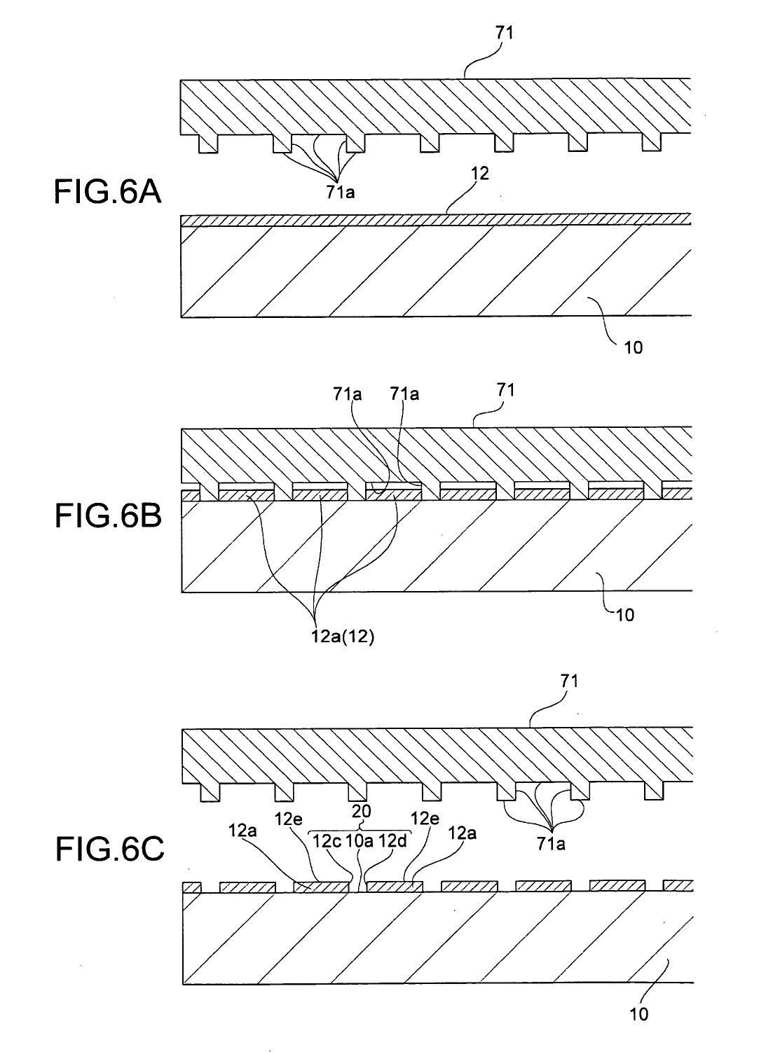

FIGS. 6A though 6C are sectional views of the substrate showing a process of directly forming the bank by a printing method called an emboss method.

In FIG. 6A, the bank film 12 is formed on the substrate 10 in the way described above and once hardened by drying, heating or light irradiation. Here, the bank film 12 may be sensitive or insensitive to light or heat. As the insensitive type one, there is a coating medium and the like.

In FIG. 6B, other original plate member 71 having a plate shape and a bank pattern part 71a formed of the resist film or by the etching is provided aside from the substrate 10, and the bank pattern part 71a is arranged so as to oppose the bank film 12. The bank film 12 is bonded to the bank pattern part 71a of the original plate member 71 and then adequately pressed. The bank film 12 can be deformed by giving heat if necessary, and molded according to the groove of the bank pattern part 71a. Accordingly, the bank film 12 opposes the bank pattern part 71a.

In FIG. 6C, the original plate member 71 and the bank pattern part 71a are separated from the substrate 10 and the desired necessary bank film 12a is obtained. The necessary bank film 12a is provided in a desired pattern on the substrate 10 through the above-mentioned process. A concave portion that consists of the bank wall side face 12c of one necessary bank film 12a, the bank wall side face 12d of the other necessary bank film 12a opposing the necessary bank film 12a and the surface 10a of the substrate 10 is formed and this becomes the bank groove part 20. The upper face of the necessary bank film 12a is also called the bank upper face 12e in this embodiment.

Process of Forming Bank Directly on Substrate by Printing Method

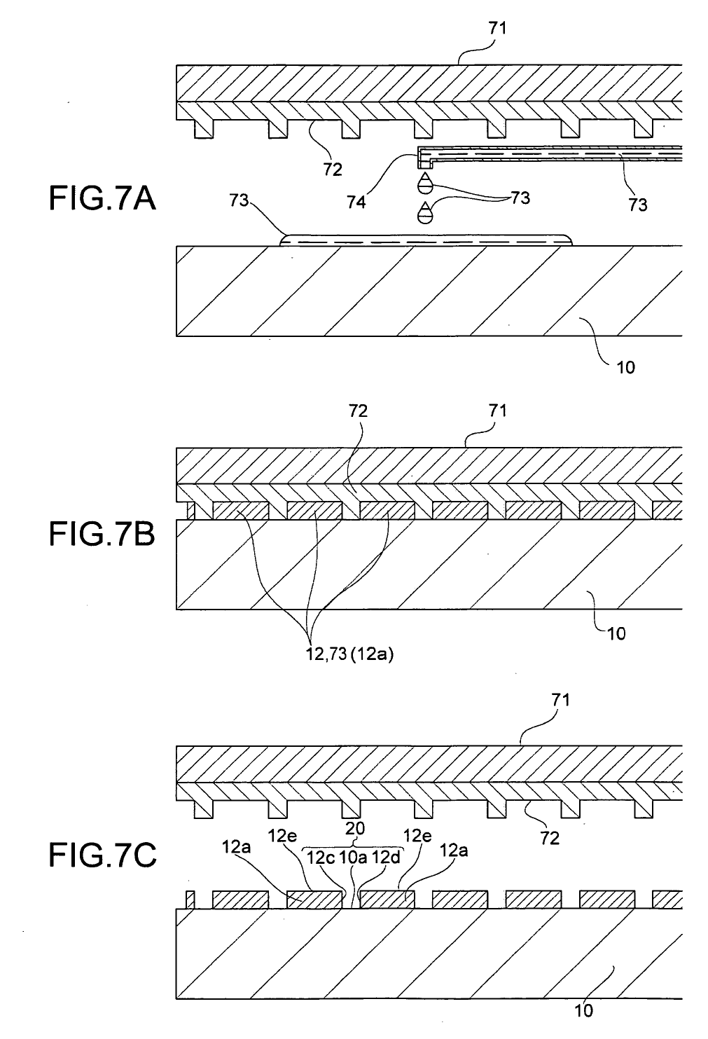

FIGS. 7A though 7C are sectional views of the substrate showing a process of directly forming the bank by a printing method called the imprint method.

In FIG. 7A, an appropriate amount of a bank liquid material 73 is provided on the substrate 10 by a bank liquid material feed unit 74. The bank liquid material 73 may be once semi-solidified by drying, heating or light irradiation.

In FIG. 7B, the original plate member 71 having a bank pattern part 72 formed by of the resist film or by the etching is prepared. This bank pattern part 72 is placed so as to oppose the bank liquid material 73 provided on the substrate 10 or the semisolid bank film 12. The bank liquid material 73 or the bank film 12 is firmly attached to the bank pattern part 72 formed on the original plate member 71 and they are adequately pressed together. In this way, the bank liquid material 73 or the bank film 12 is deformed and then spreads into the groove of the bank pattern part 72 on the original plate member 71. The bank liquid material 73 or the bank film 12 is then solidified by drying heating or light irradiation while it is under the pressure. Here, the bank liquid material 73 or the bank film 12 may be sensitive or insensitive to light or heat. As the insensitive type one, there is a coating medium and the like.

In FIG. 7C, the bank pattern part 72 and the original plate member 71 are separated from the bank film 12 and the desired necessary bank film 12a is obtained. The necessary bank film 12a is provided in a desired pattern on the substrate 10 through the above-mentioned process. The concave portion consisting of the bank wall side face 12c of one necessary bank film 12a, the bank wall side face 12d of the other necessary bank film 12a opposing the necessary bank film 12a and the surface 10a of the substrate 10 is formed and this becomes the bank groove part 20. The upper face of the necessary bank film 12a is also called the bank upper face 12e in this embodiment.

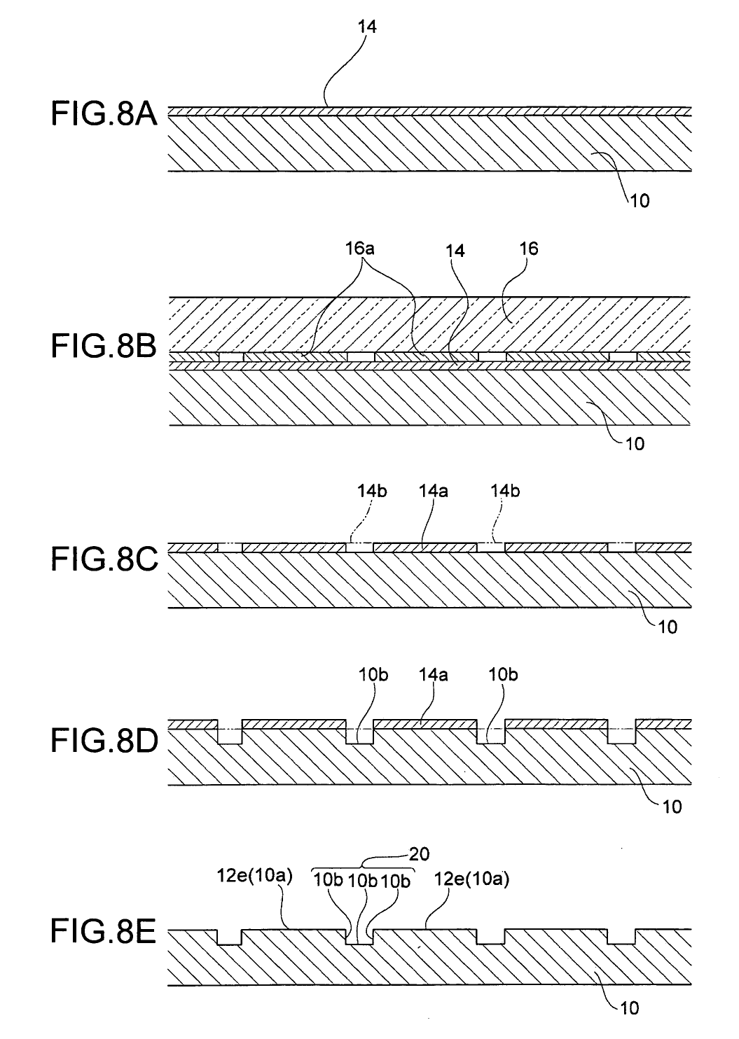

FIGS. 8A though 8E are sectional views of the substrate explaining a process (S121, S124, S125) of forming the bank by etching the substrate by the photolithography in the flow chart shown in FIG. 1 FIG. 8A shows S121 of forming the resist 14 on the substrate 10. The forming method and the material of the resist are the same as those in S106. A difference between S121 and S106 is that the bank film 12 is not provided on the substrate 10 instead the resist 14 is formed on the substrate 10.

FIG. 8B shows S121 in which the photomask 16 is formed. Parallel light is emitted through a part where the photomask pattern 16a is not formed. Only the resist 14 which opposes the part where the photomask pattern 16a is not formed is irradiated with the parallel light.

FIG. 8C shows S121 in which the resist 14 irradiated with the light is chemically reacted by the light and becomes soluble in a developing agent. When the surface of the resist 14 is sufficiently dipped in the developing agent, the unnecessary resist 14b dissolves in the developing agent. On the contrary, the necessary resist 14a does not dissolve in the developing agent. The necessary resist 14a may be heated in order to increase adhesiveness to the bank film 12.

FIG. 8D shows S121 in which a solvent (hereinafter called a substrate etching solution) dissolving the substrate 10 is provided on the surface of the necessary resist 14a and the substrate 10, and then a part of the substrate where the necessary resist 14a does not exist is dissolved and removed to create a desired depth. In this way, a desired concave pattern 10b is obtained. The substrate etching solution is not especially limited as long as it does not dissolve the necessary resist 14a but the substrate 10.

FIG. 8E shows S124 in which the necessary resist 14a is removed by a parting agent, and the desired pattern 10b which is a concave portion on the etched substrate can be obtained. In this embodiment, this concave pattern 10b is used as the bank groove part 20. A surface 10c of the substrate 10 where the etching is not performed is called the bank upper face 12e in this embodiment.

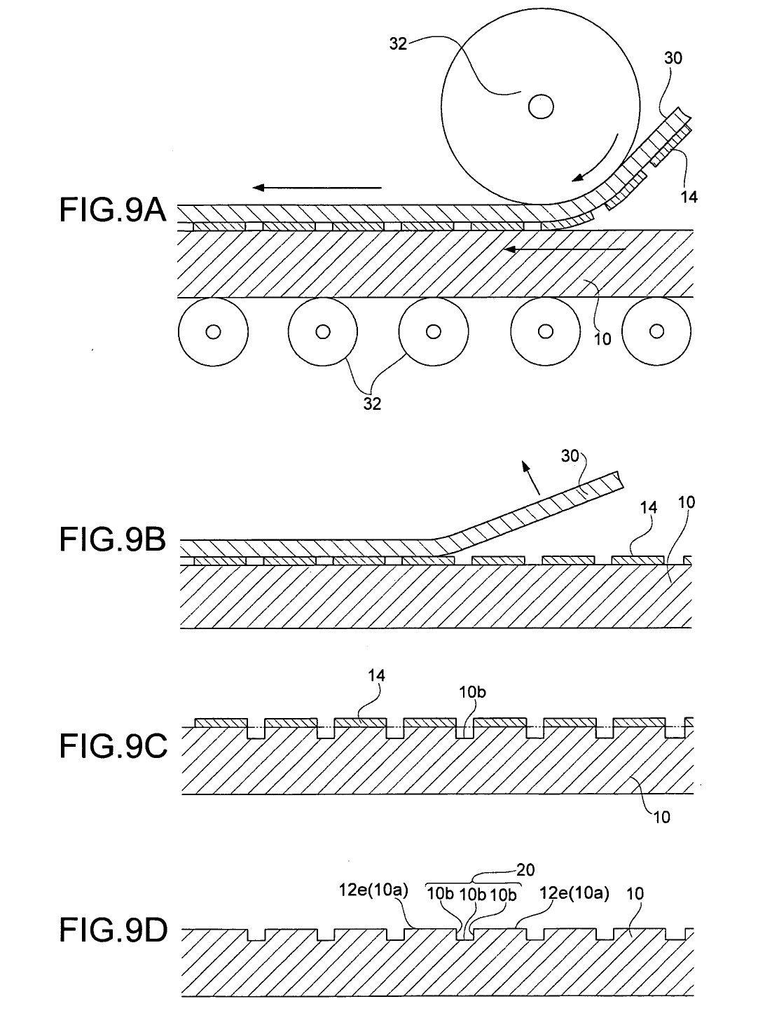

FIGS. 9A though 9D are sectional views of the substrate explaining a process (S122, S124, S125) of forming the bank by etching the substrate by the transfer method in the flow chart shown in FIG. 1.

FIG. 9A is a sectional view of the substrate for explaining S122 in which a film with a resist and the substrate are bonded together by pressing. The resist 14 made of an organic material is formed in a predetermined pattern on the film 30 in advance by the photolithography method or the printing method and the like. The film with the resist and the substrate 10 opposing the face of the film on which the resist 14 is formed are put together between rollers. A distance between each roller 32 is adjusted. The plurality of the rollers 32 creates pressure among the film 30, the resist 14 and the substrate 10, and the resist 14 and the substrate 10 are bonded by the pressure. The roller or the air around the roller may be heated.

FIG. 9B is a sectional view of the substrate for explaining S122 in which the film is separated from the bonded resist. The adhesion between the film 30 and the resist 14 is smaller than the adhesion between the substrate 10 and the resist 14. Accordingly, when the film 30 is lifted, only the film 30 is separated while the resist 14 is still attached to the substrate 10. The material for the film 30 is not particularly limited as long as it has the enough adhesion such that the film 30 will not be separated from the resist 14 during the working process. Such material may be mainly fluorine series resin.

FIG. 9C shows S124 in which a solvent (hereinafter called the substrate etching solution) dissolving the substrate 10 is provided on the surface of the resist 14 and the substrate 10, and then a part of the substrate where the resist 14 does not exist is dissolved and removed to create a desired depth. In this way, a desired concave pattern 10b is obtained. The substrate etching solution is not especially limited as long as it does not dissolve the resist 14 but the substrate 10.

FIG. 9D shows S125 in which the resist 14 is removed by a parting agent, and the desired pattern 10b which is a concave portion on the etched substrate can be obtained. In this embodiment, this concave pattern 10b is used as the bank groove part 20. The surface 10a of the substrate 10 where the etching is not performed is called the bank upper face 12e in this embodiment.

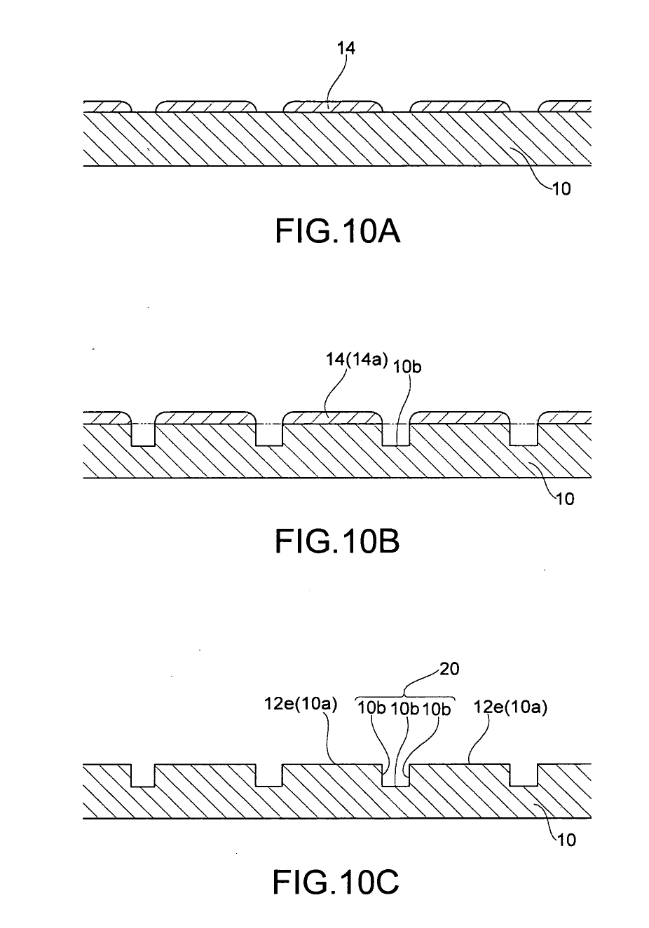

FIGS. 10A though 10C are sectional views of the substrate explaining a process (S123, S124, S125) of forming the bank by etching the substrate by the printing method in the flow chart shown in FIG. 1.

FIG. 10A shows S123 in which the resist 14 is directly provided in a desired pattern on the substrate by the screen printing method or the offset printing method. The printed resist 14 and the substrate 10 are bonded together by heating, and the resist 14 is solidified. The resist 14 may be sensitive or insensitive to light. As the insensitive type of the resist, there is a coating medium and the like.

FIG. 10B shows S124 in which a solvent (hereinafter called the substrate etching solution) dissolving the substrate 10 is provided on the surface of the resist 14 and the substrate 10, and then a part of the substrate where the resist 14 does not exist is dissolved and removed to create a desired depth. In this way, a desired concave pattern 10b is obtained. The substrate etching solution is not especially limited as long as it does not dissolve the necessary resist 14a but the substrate 10.

FIG. 10C shows S125 in which the resist 14 is removed by a parting agent, and the desired pattern 10b which is a concave portion on the etched substrate can be obtained. In this embodiment, this concave pattern 10b is used as the bank groove part 20. The surface 10a of the substrate 10 where the etching is not performed is called the bank upper face 12e in this embodiment.

Process of Giving Lyophilicity to Part or Whole of Substrate and Bank

Next, a lyophilic quality is given to a part or whole of the bank groove 20 formed on the substrate 10 in S101-S110 shown in FIG. 1, the bank groove 20 formed by etching the substrate in S120-S125 shown in FIG. 1, and the bank upper face 12e formed by the corresponding method.

A process of giving the lyophilic quality (lyophilic treatment) is a treatment for making things easy to be wet with water. This treatment is performed to a part or whole of the bank groove 20, the substrate 10 and the bank upper face 12e. As specific examples of the lyophilic treatment, there are ozone oxidation treatment, plasma treatment, corona treatment, ultraviolet irradiation treatment, electron irradiation treatment, acid treatment, alkali treatment and the like. This treatment is performed according to surface properties of the bank groove 20, the substrate 10 and the bank upper face 12e. For example, when the surface of the bank groove 20 made of the organic material or the surface of the substrate 10 contains a polar radical such as hydroxyl group, aldehyde group, ketone group, amino group, imino group, carboxyl group and silanol group, this lyophilic treatment can be omitted.

The bank groove 20 and the substrate 10 after the lyophilic treatment shows the contact angle of smaller than 20° against water.

Process of Applying Lyophobic Agent to Part or Whole of Upper Face of Bank

Next, a process of applying a lyophobic agent to a part or whole of the above-mentioned bank upper face 12e is described. This process is a treatment for making the part or whole of the bank upper face 12e difficult to be wet.

A lyophobic agent 50 is attached to an original plate member 51 which is other plate than the substrate 10. The lyophobic agent 50 is transferred to the part or whole of the bank upper face 12e by contacting the original plate member 51 with the bank upper face 12e of the substrate 10. In this way, the lyophobic quality is given to the bank upper face 12e.

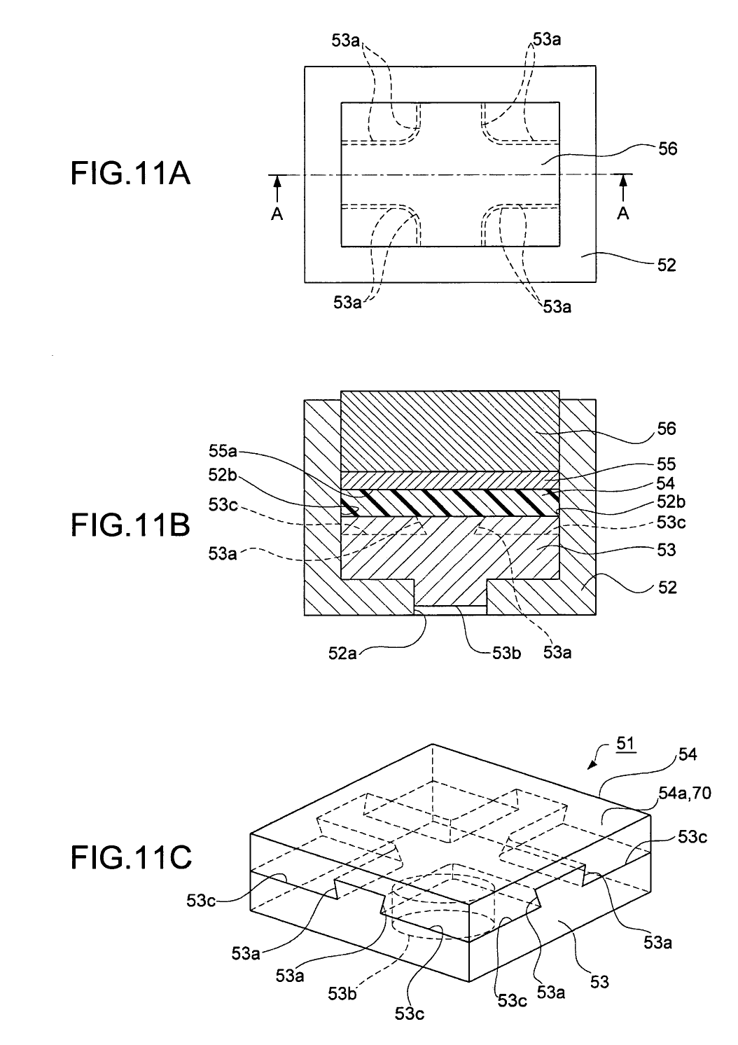

FIGS. 11A though 11C are plan sectional views and a perspective view showing a fabrication process of the original plate member.

FIG. 11A is a plan view of an original plate member showing its fabrication process. FIG. 11B is a sectional view of the original plate member along the line A-A in FIG. 11A. FIG. 11C is a perspective view of the completed original plate member.

In FIGS. 11A and 11B, to fabricate the plate member 51, firstly, a stamp member 53 is placed from above a mold form 52. A guide hole 52a is provided on the bottom of the mold form 52, and a protruding part 53b that extends downward from the stamp member 53 is engaged with the guide hole 52a. The mold form 52 and the stamp member 53 are also engaged. A protruding part having a pair of inclined faces 53a whose distance can be shorten in downward direction is provided above the stamp member 53.

After placing the stamp member 53 from above the mold form 52, a liquid stamp material 54 is poured into a concave portion that consists of the mold form 52 and the stamp 53. The liquid stamp material 54 is kept pouring into the portion until it fills an area where includes a face 53c of the stamp member 53, the inclined face 53a and an inner wall face 52b of the mold form 52.

After filling the liquid stamp material 54, a plate 55 made of, for example, silicon wafer, glass and the like and having at least one smooth flat face 55a is placed on the mold form 52 from above, and the liquid stamp material 54 is interposed therebetween. At this time, some of the liquid stamp material 54 is applied in advance on the smooth flat face 55a of the plate 55 in order to prevent air from being contained between the smooth flat face 55a of the plate 55 and the liquid stamp material 54. The plate 55 is not especially limited as long as it has a flat face.

After placing the plate 55 on the mold form 52, a bias member 56 is placed. In this embodiment, a momentum is given to the plate 55 and the liquid stamp material 54 by utilizing the weight of the bias member 56. However, the momentum may be given by an air cylinder or a spring, or attaching the bias member 56 to the mold form 52 in a spiral manner.

The above-described set of the original plate on which each member is mounted is left at room temperature for 24 hours. The set of the original plate may be heated. This process makes the liquid stamp material 54 harden as it keeps its elasticity.

The material for the liquid stamp material 54, which is the material of the original plate, will now be described. Polydimethylsiloxane (PDMS) (KE1310ST manufactured by Shin-Etsu Chemical Co., Ltd.) is used as the material for the liquid stamp material 54. After resin material that is hardened by an addition type reaction mechanism and curing agent are mixed into the PDMS, it is hardened by leaving at room temperature for 24 hours or heating and leaving as it keeps the elasticity.

For example, when elastomer is formed by reacting the liquid stamp material 54, the reaction may be either condensation or addition. However, when the condensation which shows about 0.5% liner shrinkage is adopted, a gas is generated on its reacting process of polymer. Therefore, it is preferable that an elastic material formed by the addition type reaction mechanism with about 0.1% liner shrinkage is used.

It is also preferable that the elastomer having a siloxane structure is used as the liquid stamp material 54 in order to enhance adhesion with the substrate 10. As such elastomer, for example, silane compound, polydimethylsiloxane (PDMS) series elastomer can be named. The structural formula of this polymer is “Si(CH₃)₃—O—(Si(CH₃)₂O)n-Si(CH₃)₃ (where n is positive integer)”. By using this material, a surface treatment agent applied on the substrate 10, which will be described later, can be absorbed or attached to the molded original plate surface 54a.

FIG. 11C is a perspective view of the original plate member 51 which is the hardened stamp material 54 as it keeps the elasticity taken out from the mold form 52. The stamp material 54 is adhered so as to cover a plurality of the inclined faces 53a and a plurality of faces 53c of the stamp member 53. The protruding part 53b provided on the stamp member 53 is used for mounting the original plate member 51 on other device in a hereinafter described process. The original plate surface 54a of the stamp material 54 is made to be flat and smooth with the smooth flat face 55a of the plate 55.

As a surface treatment agent 70, a volatile polymer solution (Unidyne TG-656 manufactured by Daikin Industries, Ltd.) is applied to the original plate surface 54a by a spinner with a spin of 3000 rpm for 30 seconds. This application of the surface treatment agent 70 gives the lyophobic quality to the original plate surface 54a.

Process of Applying Lyophobic Agent to Part or Whole of Upper Face of Bank

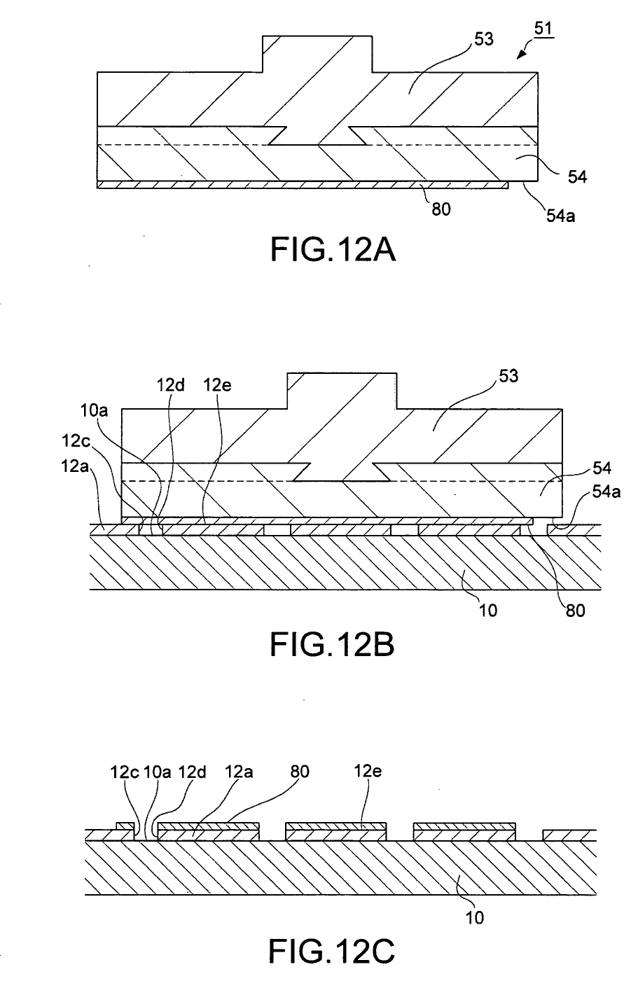

FIGS. 12A through 12C are sectional views of the substrate 10 and the original plate member 51 explaining a process of applying the lyophobic agent 80 on a part or whole of the bank upper face 12e formed on the substrate 10.

FIG. 12A is a sectional view of the original plate member 51 on which the lyophobic agent 80 is applied. The lyophobic agent 80 is applied on a part or whole of the original plate surface 54a of the stamp material 54 that is provided on the original plate member 51. As the lyophobic agent 80, for example, a silane coupling agent (organosilicon compound) and a surface active agent having a functional group, which is selectively and chemically absorbed to a constituent atom of the substrate, on the molecule end can be used.

The silane coupling agent used here is a compound represented by R¹SiX¹mX²(3−m) (where R¹ is an organic group, X¹ and X² are —OR₂, —R₂, —Cl, R₂ is an alkyl group with the carbon number of 1-4 and m is an integer of 1-3).

The surface active agent used here is a compound represented by R¹Y¹ where Y¹ denotes a lyophilic polar group such as —OH, —(CH₂CH₂O)nH, —COOH, —COOK, —COONa, —CONH₂, —SO₃H, —SO₃Na, —OSO₃H, —OSO₃Na, —PO₃H₂, —PO₃Na₂, —PO₃K₂, —NO₂, —NH₂, —NH₃Cl (ammonium salt), —NH₃Br (ammonium salt), ≡NHCl (pyridinium salt) and ≡NHB (pyridinium salt).

The silane coupling agent is characterized by chemical absorption to hydroxyl groups existing on the substrate surface. It can be appropriately used as the lyophobic agent 80 since it has reactivity with the surface of a wide range of oxides such as metals and insulators. Among these silane coupling agent and surface active agent, especially the one modified with fluorine atom-containing compound having perfluoroalkyl structure CₙF₂ₙ+1 or perfluoroalkylether structure CₚF₂ₚ₊₁O(CₚF₂ₚO)r for R¹ is appropriate because the surface free energy of the solid surface becomes lower than 25 mJ/m² and its affinity for polarized material becomes small.

More specifically, as the silane coupling agent, there are CF₃—CH₂CH₂—Si(OCH₃)₃, CF₃(CF₂)₃—CH₂CH₂—Si(OCH₃)₃, CF₃(CF₂)₅—CH₂CH₂—Si(OCH₃)₃, CF₃(CF₂)₅—CH₂CH₂—Si(OC₂H₅)₃, CF₃(CF₂)₇—CH₂CH₂—Si(OCH₃)₃, CF₃(CF₂)₁₁—CH₂CH₂—Si(OC₂H₅)₃, CF₃(CF₂)₃—CH₂CH₂—Si(CH₃)(OCH₃)₂, CF₃(CF₂)₇—CH₂CH₂—Si(CH₃)(OCH₃)₂, CF₃(CF₂)₈—CH₂CH₂—Si(CH₃)(OC₂H₅)₂, CF₃(CF₂)₈—CH₂CH₂—Si(C₂H₅)(OC₂H₅)₂, CF₃O(CF₂O)₆—CH₂CH₂—Si(OC₂H₅)₃, CF₃O(C₃F₆O)₄—CH₂CH₂—Si(OCH₃)₃, CF₃O(C₃F₆O)₂(CF₂O)₃—CH₂CH₂—Si(OCH₃)₃, CF₃O(C₃F₆O)₈—CH₂CH₂—Si(OCH₃)₃, CF₃O(C₄F₉O)₅—CH₂CH₂—Si(OCH₃)₃, CF₃O(C₄F₉O)₅—CH₂CH₂—Si(CH₃)(OC₂H₅)₂, CF₃O(C₃F₆O)₄—CH₂CH₂—Si(C₂H₅)(OCH₃)₂ and the like. However, the silane coupling agent is not limited to the above-mentioned structures.

As the surface active agent, there are CF₃—CH₂CH₂—COONa, CF₃(CF₂)₃—CH₂CH₂—COONa, CF₃(CF₂)₃—CH₂CH₂—NH₃Br, CF₃(CF₂)₅—CH₂CH₂—NH₃Br, CF₃(CF₂)₇—CH₂CH₂—NH₃Br, CF₃(CF₂)₇—CH₂CH₂—OSO₃Na, CF₃(CF₂)₁₁—CH₂CH₂—NH₃Br, CF₃(CF₂)₈—CH₂CH₂—OSO₃Na, CF₃O(CF₂O)₆—CH₂CH₂—OSO₃Na, CF₃O(C₃F₆O)₂(CF₂O)₃—CH₂CH₂—OSO₃Na, CF₃O(C₃F₆O)₄—CH₂CH₂—OSO₃Na, CF₃O(C₄F₉O)₅—CH₂CH₂—OSO₃Na, CF₃O(C₃F₆O)₈—CH₂CH₂—OSO₃Na and the like. However, the surface active agent is not limited to the above-mentioned structures.

Moreover, lyophobic polymer compounds can also be used as the lyophobic agent 80. As such lyophobic polymer compounds, for example, there are fluorine atom-containing oligomer and polymer. To be more specific, there are ethylene, ester, acrylate, methacrylate, vinyl, urethane, silicon, imide and carbonate polymers having long-chain perfluoroalkyl structure such as polytetrafluoroethylene (PTFE), ethylene-tetrafluoroethylene copolymer, hexafluoropropylene-tetrafluoroethylene copolymer, polyvinylidene fluoride (PVdF), poly(pentadecafluoroheptyl-ethylmethacrylate) (PPFMA) and poly(perfluorooctylethyl acrylate).

In order to prevent the lyophobic agent 80 from having affect on the bank groove 20, the thickness of the film of the transferred lyophobic agent 80 is preferably equal to or smaller than 10 nm, more preferably, equal to or smaller than 5 nm.

General application method can be used to apply the lyophobic agent 80 to the original plate surface 54a of the stamp material 54. For example, there are an extrusion coating method, a spin-coating method, a gravure coating method, a reverse roll coating method, a rod coating method, a slit coating method, a micro gravure coating method, a dip coating method, an ink-jet coating method and the like.

FIG. 12B is a sectional view of a substrate 10 and the original plate 51 explaining a process of transferring the lyophobic agent 80 on the original plate surface 54a to the bank upper face 12e of the substrate 10 by contacting the original plate surface 54a on which the lyophobic agent 80 is applied with the bank upper face 12e of the substrate 10. Firstly, parallelization between the original plate surface 54a and the bank upper face 12e of the substrate 10 is adjusted. Then, the original plate surface 54a and the bank upper face 12e of the substrate 10 are biased so as to deform the elastic stamp material 54 in some degree. The lyophobic agent 80 is not applied on the bank wall side face 12c and the bank wall side face 12d. The above-mentioned lyophilicity of the bank wall side face 12c, the bank wall side face 12d and the surface 10a of the substrate 10 is reserved. The height (thickness) of the necessary bank film 12a is preferably equal to or more than 1 μm in order to prevent the lyophobic agent 80 from attaching to the bank groove 20 when the stamp material 54 deforms in some degree.

FIG. 12C is a sectional view of the substrate 10 showing that the original plate member 51 is separated from the bank upper face 12e of the substrate 10 and the lyophobic agent 80 is transferred on the bank upper face 12e of the substrate 10. The lyophobic agent 80 is transferred to only a part where the original plate surface 54a and the bank upper face 12e of the substrate 10 contact each other. The lyophobic agent 80 is not transferred to the other part where the original plate surface 54a and the bank upper face 12e of the substrate 10 do not contact. This is about transferring the agent to a part of the bank upper face 12e. The agent may be transferred to a whole of the bank upper face 12e.

In order to increase the lyophobicity of the lyophobic agent 80 transferred on the bank upper face 12e, it is preferable that a step of fixing the lyophobic agent 80 to the substrate 10, more specifically, a heating treatment or a treatment to expose the agent to a reactive vapor, is performed after the transferring process. In a case of the silane coupling agent, for example, the reaction is promoted by heating the substrate to a high temperature or exposing the substrate to a high-humidity environment at a room temperature. Giving a specific example, the substrate is heated for 1 minuet in an oven heated to 150° C. in order to set the reaction of the lyophobic polymer in the lyophobic agent 80 to the bank upper face 12e of the substrate 10.

The applied lyophobic agent 80 is fixed on the substrate 10 in this way, and a thin film of the lyophobic polymer of the lyophobic agent 80 is formed only on the bank upper face 12e of the substrate 10. The lyophobic polymer of the transferred lyophobic agent 80 gives the lyophobicity to the surface and the bank upper face 12e shows a high contact angle of more than 90° against water.

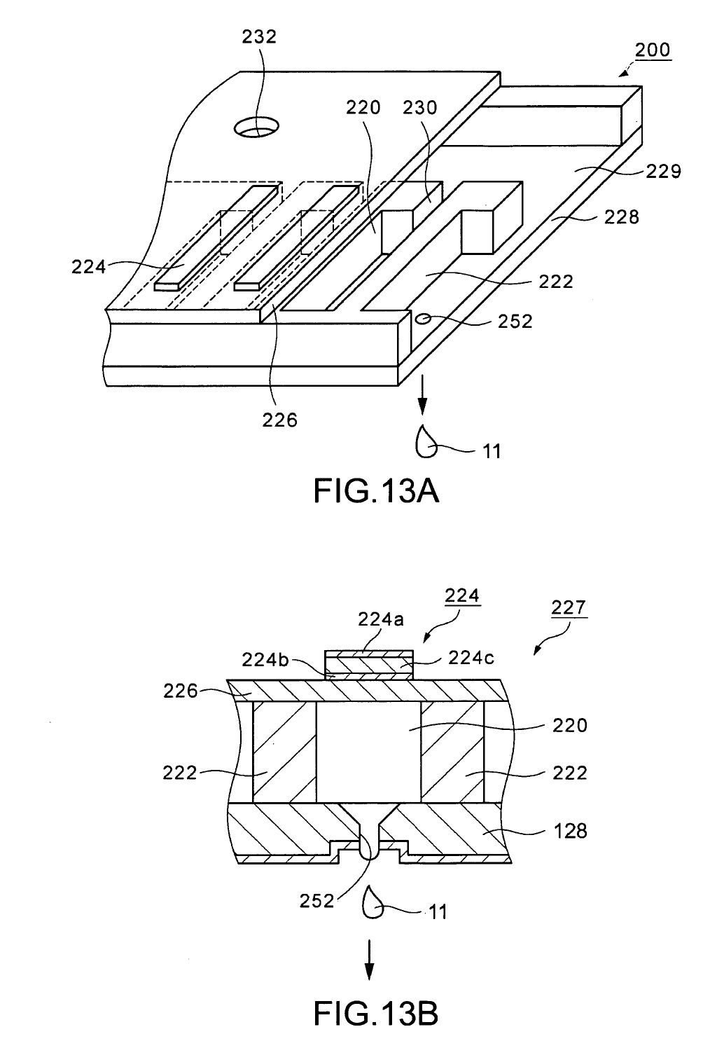

FIG. 13A is a sectional perspective view of a droplet discharge head 200. FIG. 13B is a detailed sectional view of a discharge part. Every droplet discharge head 200 is an ink-jet droplet discharge head. The droplet discharge head 200 has a vibrating board 226 and a nozzle plate 228. A liquid storage 229 is provided between the vibrating board 226 and the nozzle plate 228. The liquid storage 229 is always filled with conductive liquid material 11 as the ink that is provided from a tank (not shown in the figures) to an opening 232 through a tube (not shown in the figures).

A dividing wall 222 is located between the vibrating board 226 and the nozzle plate 228. The dividing wall 222 is provided in a plural number. And a part that is surrounded by the vibrating board 226, the nozzle plate 228 and a pair of the dividing walls 222 is a cavity 220. The number of the cavity 220 and the number of a nozzle 252 are same because the cavity 220 is provided corresponding to the nozzle 252. The conductive liquid material 11 is provided into the cavity 220 from the liquid storage 229 through a feed opening 230 that is located between the pair of the dividing walls 222.

An oscillator 224 is provided on the vibrating board 226 corresponding to each cavity 220 as shown in FIG. 13B. The oscillator 224 includes a piezoelectric element 224c, a pair of electrodes 224a and 224b that sandwiches the piezoelectric element 224c. The conductive liquid material 11 is discharged form the correspondent nozzle 252 by applying a driving voltage to the pair of electrodes 224a and 224b. The shape of the nozzle 252 is adjusted so as to discharge the conductive liquid material 11 in the Z-axis direction from the nozzle 252.

In this embodiment, the conductive liquid material 11 refers to a material having a viscosity with which the material can be discharged from the nozzle. In this case, the material can be both water-based and oil-based material. It is enough to have liquidity (the viscosity) with which the material can be discharged from the nozzle, and it may even contain a solid matter as long as it can be taken as fluid as a whole.

The viscosity of the conductive liquid material 11 is preferably above 1 mPa·s and below 50 mPa·s. This is because when the conductive liquid material 11 is discharged in the droplet form, if the viscosity is smaller than 1 mPa·s, the area around the nozzle is easily contaminated with a spillage of the conductive liquid material 11. If the viscosity is higher than 50 mPa·s, the frequency of clogging occurring at the nozzle 252 increases, making it difficult to smoothly discharge droplets.

In this embodiment, a part that includes the one nozzle 252, the cavity 220 corresponding to the nozzle 252 and the oscillator 224 corresponding to the cavity 220 may be referred as a discharging member 227. According to such description, the one droplet discharge head 200 has the same number of the discharging member 227 as that of the nozzle 252. In stead of the piezoelectric element, the discharging member 227 may have an electrothermal converting element. In other words, the discharging member 227 may have a structure in which the material is discharged making use of a thermal expansion of the material with the electrothermal converting element.

The material of the conductive liquid material 11 is now described. The conductive liquid material 11 that becomes the conductive pattern contains at least one of conductive particles or organometal compound. It is discharged from a droplet discharge device (not shown in the figures), provided on the substrate at a predetermined position in a predetermined shape and becomes the conductive pattern. As the conductive liquid material 11 containing at least one of the conductive particles or the organometal compound, there are a dispersion liquid in which the conductive particles dispersed in a dispersion medium, a liquid organometal compound, an organometal compound solution or these liquids combined.

As the conductive particles used here, for example, there are metal particles which contain at least one of gold, silver, copper, palladium, or nickel, and oxidized substances thereof, a conductive polymer and superconductive particles.

To increase the dispersibility of these conductive particles, the surface of the particle may be coated with an organic solvent such as xylene and toluene, or citric acid and the like. The diameter of the conductive particle is preferably above 1 nm and below 0.1 μm. When it is larger than 0.1 μm, there is a concern of clogging at the nozzle of the liquid discharge head that is described later. When it is smaller than 1 μm, the volume ratio of the coating material to the particle becomes large and the ratio of the organic matter which can be obtained in the film to become excessive. When the conductive particle coated with the coating material is used, it is possible to use an ink which does not show conductivity in the liquid form but shows the conductivity when it is dried or sintered.

As the coating material for the conductive particles, amine, alcohol and thiol are known. More specifically, amine compounds such as 2-methylaminoethanol, diethanolamine, diethylmethylamine, 2-dimethylaminoethanol and methyldiethanolamine, alkylamine series, ethylenediamine, alkylalcohol series, ethylene glycol, propylene glycol, alkylthiol series and ethanedithiol can be used as the coating material for the conductive particles.

As the organometal compound, for example, compounds or complexes that containes, for example, gold, silver, copper and palladium and separates out the metal by thermal decomposition can be used. To be more specific, there are chlorotriethylphosphine-gold(I), chlorotrimethylphosphine-gold(I), chlorotriphenylphosphine-gold(I), silver(I)2,4-pentanedionato complex, trimethylphosphine (hexafluoroacetylacetonate)-silver(I) complex, copper(I) hexafluoropentanedionatocyclooctadiene complex and the like.

As for the liquid dispersion medium or the solvent containing at least one of the conductive particles or the organometal compound, its vapor pressure at room temperature is preferably above 0.001 mmHg and below 200 mmHg (about above 0.133 Pa and below 26600 Pa). This is because when the vapor pressure is higher than 200 mmHg, the dispersion medium or the solvent discharged will be quickly evaporated and this makes it difficult to form a fine film.

Moreover, the vapor pressure of dispersion medium or the solvent is preferably above 0.001 mmHg and below 50 mmHg (about above 0.133 Pa and below 6650 Pa). This is because when the vapor pressure is higher than 50 mmHg, the nozzle tends to clog up with dryness at the time of discharge of the droplets by the droplet discharge method, and it is hard to secure a stable discharge. In contrast, when the dispersion medium or the solvent with the vapor pressure at room temperature is lower than 0.001 mmHg is used, it will take a long time to dry and the dispersion medium or the solvent is likely to remain in the film. This makes it difficult to obtain a fine conductive film after a thermal treatment or/and a light exposure treatment of a post-process is performed.

The dispersion medium is not particularly limited as long as it can disperse the above-mentioned conductive particles therein without condensation. For example, the examples include, in addition to water, alcohol such as methanol, ethanol, propanol and butanol, hydrocarbon compounds such as n-heptane, n-octane, decane, decane, dodecane, tetradecane, toluene, xylene, cymene, dulene, indent, dipentene, tetrahydronaphthalene, decahydronaphthalene and cyclohexylbenzene, ether compounds such as ethyleneglycoldimethyl ether, ethyleneglycoldiethyl ether, ethyleneglycolmethylethyl ether, diethyleneglycoldimethyl ether, diethylenglycoldiethyl ether, diethyleneglycolmethylethyl ether, 1,2-dimethoxyethane, bis (2-methoxyethyl)ether, and p-dioxane, and polar compounds such as propylene carbonate, [gamma]-butyrolactone, N-methyl-2-pyrolidone, dimethylformamide, dimethylsulfoxide and cyclohexanone. Among these, water, alcohol, hydrocarbon compounds and ether compounds are preferable in terms of the dispersibility of the particles, stability of the dispersion liquid, and easy application to the droplet discharge method (inkjet method). Water and hydrocarbon compounds are especially preferable as the dispersion medium.

In a case that the above-mentioned conductive particles are dispersed in the dispersion medium, a concentration of the dispersoid is preferably about 1-80% by weight and it can be adjusted depending on a thickness of the desired conductive film. When the concentration is more than 80% by weight, aggregation tends to occur and it gets difficult to obtain a uniform film. For the same reason, a solute concentration of the organometal compound solution preferably lies in the same range as that of the concentration of the dispersoid.

It is preferable that the surface tension of the dispersion liquid of the above-mentioned conductive particles is in the range of 0.02 N/m to 0.07 N/m. This is because when liquid is discharged by the droplet discharge method, if the surface tension is less than 0.02 N/m, the wettability of the ink composition with respect to the nozzle surface increases so that the discharge direction tends to deviate. If the surface tension exceeds 0.07 N/m, the shape of the meniscus at the tip of the nozzle becomes unstable, making it difficult to control the discharge amount and the discharge timing. A good way to adjust the surface tension is to add a small amount of a surface tension modifier such as a fluorine group, silicon group, nonionic group, into the above-mentioned dispersion liquid to an extent not to largely decrease the contact angle with the substrate. The nonionic surface tension modifier increases the wettability of the liquid on the substrate, improves the leveling property of the film, and helps to prevent the occurrence of minute ruggedness on the film. The above-mentioned surface tension modifier may contain organic compounds such as alcohol, ether, ester, ketone, and the like according to need.

The viscosity of the above-mentioned dispersion liquid is preferably above 1 mPa·s and below 50 mPa·s. This is because when liquid material is discharged in the droplet form by the droplet discharge method, if the viscosity is smaller than 1 mPa·s, the area around the nozzle is easily contaminated by discharged ink. If the viscosity is higher than 50 mPa·s, the frequency of clogging occurring at the nozzle hole increases, making it difficult to smoothly discharge droplets.

As a specific example of such ink 33a for a conductive layer, there is silver particle dispersion liquid (“Perfect Silver” manufactured by Vacuum Metallurgical Co., Ltd), which is silver particles with about 10 nm diameter are dispersed in an organic solvent. The silver particle dispersion liquid is diluted by replacing the dispersion medium of the silver particle dispersion liquid by tetradecane such that the concentration becomes 60 wt %, the viscosity becomes 8 mPa·s and the surface tension becomes 0.022 N/m.

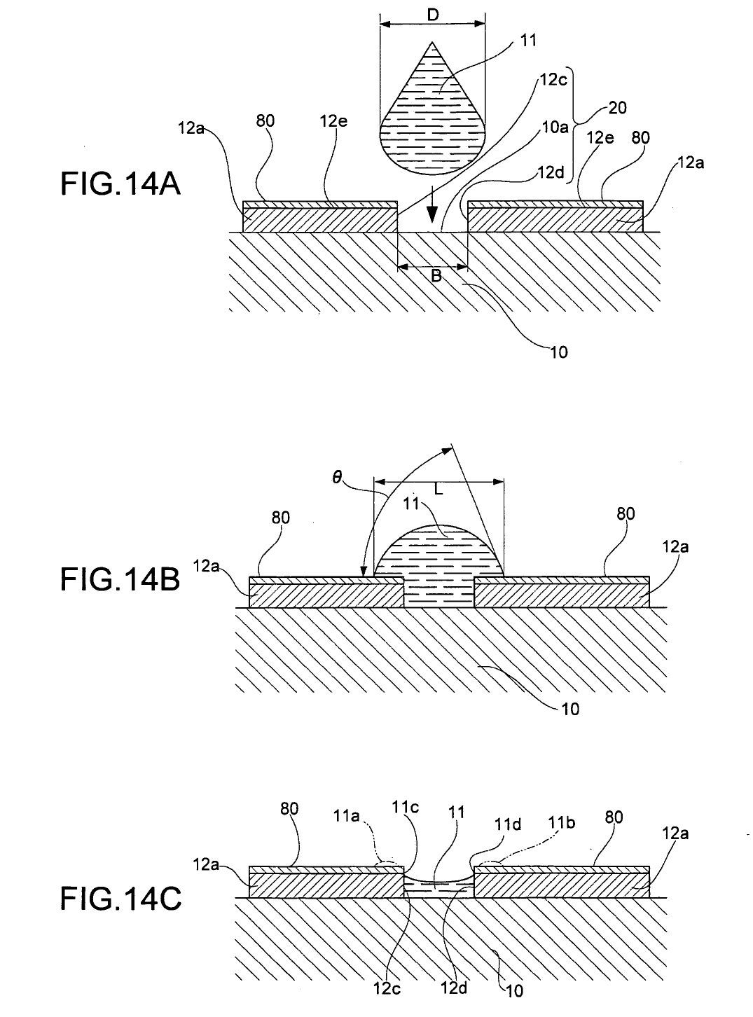

FIGS. 14A through 14C are sectional views explaining a relation between the substrate 10 and the conductive liquid material 11 discharged from the droplet discharge head 200.

As shown in FIG. 14A, the conductive liquid material 11 discharged from the droplet discharge head 200 reaches the substrate 10 in a form of cannonball. The droplet discharge device (not shown in the figures) controls the position where the droplet should be discharged and the conductive liquid material 11 is discharged to the bank groove part 20 that is composed of the bank wall side face 12c, the surface 10a of the substrate 10 and the bank wall side face 12d. The conductive liquid material 11 shown in the figure is the one discharged from the droplet discharge head 200 of the droplet discharge device. A case that a size D of the droplet of the conductive liquid material 11 is larger than a bank groove width B of the bank groove part 20 is hereinafter described.

FIG. 14B shows the scene when the conductive liquid material 11 has just reached the substrate. Since the size D of the droplet of the conductive liquid material 11 is larger than the bank groove width B of the bank groove part 20, the droplet goes over the bank groove width B of the bank groove part 20 and spreads out to the area of the lyophobic agent 80 provided on the bank upper face 12e as shown in the figure right after it reached the substrate. This shape of the droplet is denoted as L (hereinafter called a landing diameter).

As described above, the lyophobic agent 80 on the bank upper face 12e shows the high contact angle which is equal to or larger than 110° against water. Accordingly, the lyophobic agent 80 also has a high contact angle θ against the conductive liquid material 11. On the other hand, the bank groove part 20 is lyophilic as described above. Therefore, the conductive liquid material 11 landed on the substrate receives a compressive force from the lyophobic agent 80 on the bank upper face 12e and receives a tensile force from the bank groove part 20. Accordingly, the conductive liquid material 11 can spread out along the groove of the bank groove part 20 and back and forth in the vertical direction in the figure page. In a case that the bank groove width B is larger than the droplet size D, it is possible to more stably bring the conductive liquid material 11 into the bank groove part 20.

FIG. 14C shows the scene after the conductive liquid material 11 spread out along the groove of the bank groove part 20.

The conductive liquid material 11 is held in the bank groove part 20 that is placed between a boundary 11c between the lyophilic bank wall side face 12c and the lyophobic agent 80 provided on the bank upper face 12e and a boundary lid between the bank wall side face 12d and the lyophobic agent 80 provided on the bank upper face 12e. In the hitherto known bank structure, the bank wall side face 12c and the bank wall side face 12d were lyophobic so that the tensile force that pushes the conductive liquid material 11 into the bank groove part 20 was weak. Accordingly, a conductive liquid material 11a and a conductive liquid material 11b (hereinafter called the landing mark) are left on the lyophobic agent 80 while the conductive liquid material 11 is flowing into the bank groove part 20 as shown in the figure. The landing mark will acquire conductivity after the film forming treatment of the conductive liquid material 11 is performed. Therefore, this became a problem when a multilayer circuit is formed, causing electric short circuit among the layers. This impaired the electric credibility of the substrate.

Advantageous effect of this embodiment is now described.

(1) Because the bank wall side face 12c and the bank wall side face 12d are lyophilic, the force that pulls the conductive liquid material 11 into the bank groove part 20 is increased and it is possible to obtain the conductive pattern without the landing mark (the conductive liquid material 11a and the conductive liquid material 11b) even if the width of the pattern (the bank groove width B of the bank groove part 20) is smaller than the landing diameter (the droplet size D of the conductive liquid material 11).

### Second Embodiment

Next, a second embodiment is described with reference to the figures.

Only different parts from those of the first embodiment will be described in this embodiment and parts that are not described are the same as those of the first embodiment.

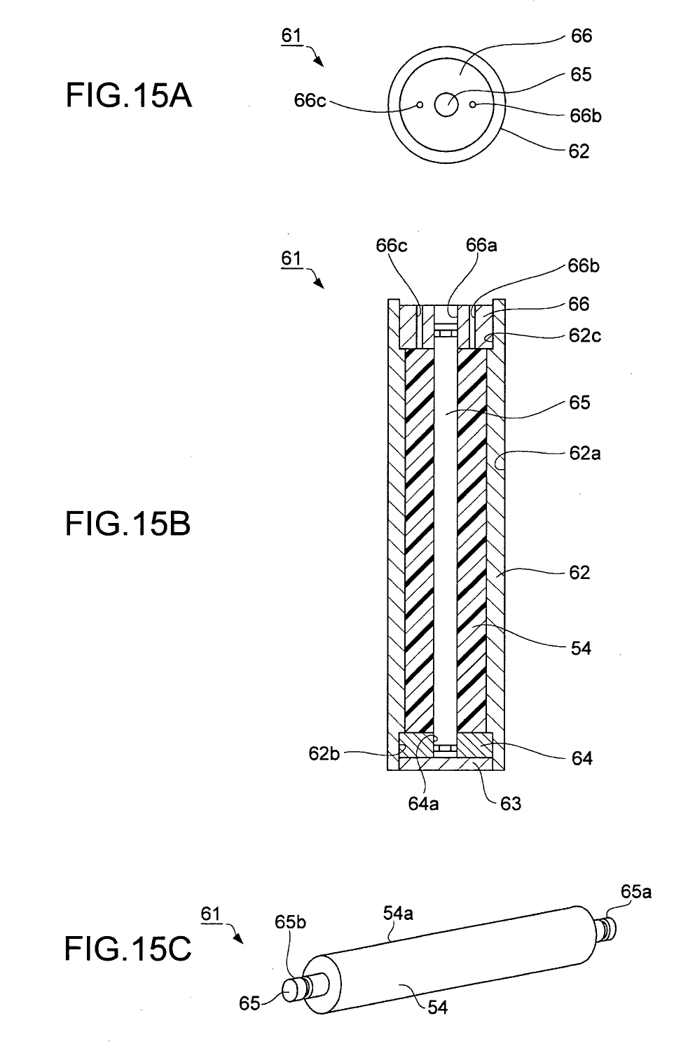

FIGS. 15A and 15B are a plan sectional view and a perspective view showing a process of forming a rolled original plate member 61.

A process of forming the rolled original plate member 61 which is a different member from the substrate 10 is described with reference to FIGS. 15A and 15B.

An inner wall 62a of the mold form 62 is processed with cylindrical grinding so as to have good roundness and cylindricality. A stepped opening 62b is provided under the mold form 62 so as to secure the same concentricity as that of the inner wall 62a. A bottom plate 64 having an opening 64a in its center is engaged with a bottom plate 63. The stamp material 54 described in the first embodiment is poured in the opening 64a.

A central axis 65 is put in from the upper side of the mold form 62, and one end of the central axis 65 is inserted into the opening 64a in the center of the bottom plate 64. A cap 66, which engages with a stepped opening 62c provided in the upper side of the mold form 62, is inserted form the upper side of the mold form 62, and the other end of the central axis 65 is engaged with an opening 66a provided on the cap 66. Excessive liquid stamp material 54 can flow outside of the mold form 62 through relief holes 66a and 66b provided on the cap 66. These members are processed in the same way as the first embodiment and the liquid stamp material 54 is solidified. Then, the solidified stamp material 54 and the central axis 65 whose part is included in the stamp material 54 are taken out from the mold form 62.

FIG. 15C shows the rolled original plate member 61 taken out from the mold form 62. Coaxiality between protruding parts 65a, 65b of the central axis 65 which protrude from the stamp material 54 and the original plate surface 54a of the stamp material 54 is measured. When the measured coaxiality is not appropriate or air bubbles exist in the original plate surface 54a of the stamp material 54, the original plate surface 54a is grinded with reference to the protruding parts 65a, 65b of the central axis 65. In this case, a heated sharp cutting tool may be used to grind since the stamp material 54 has the elasticity.

The original plate surface 54a of the stamp material 54 of the original plate member 61 is treated with the surface treatment agent 70 in the same way as the first embodiment. The original plate member 61 formed in the above-described way is placed on a roll-coating device and the like. The lyophobic agent 80 described in the first embodiment is applied in a uniform thickness on the original plate surface 54a of the stamp material 54. The applied lyophobic agent 80 is then transferred to the bank upper face 12e of the substrate 10 on which the bank groove part 20 is provided, and the film of the lyophobic agent 80 is formed.

Advantageous effect of this embodiment is now described.

(2) According to the embodiment, it is possible to continuously apply the lyophobic agent 80 on the bank upper face 12e of the substrate 10. Accordingly, the productivity can be improved.

### Third Embodiment

Next, a third embodiment is described with reference to the figures.

Only different parts from those of the first embodiment will be described in this embodiment and parts that are not described are the same as those of the first embodiment.

In this embodiment, the bank is formed by performing the emboss printing to the bank film 12 provided on the substrate 10 while the lyophobic agent 80 is applied. The necessary bank film 12a having a desired shape can be obtained and the process of giving the lyophobic quality to the bank upper face 12e is performed at the same time.

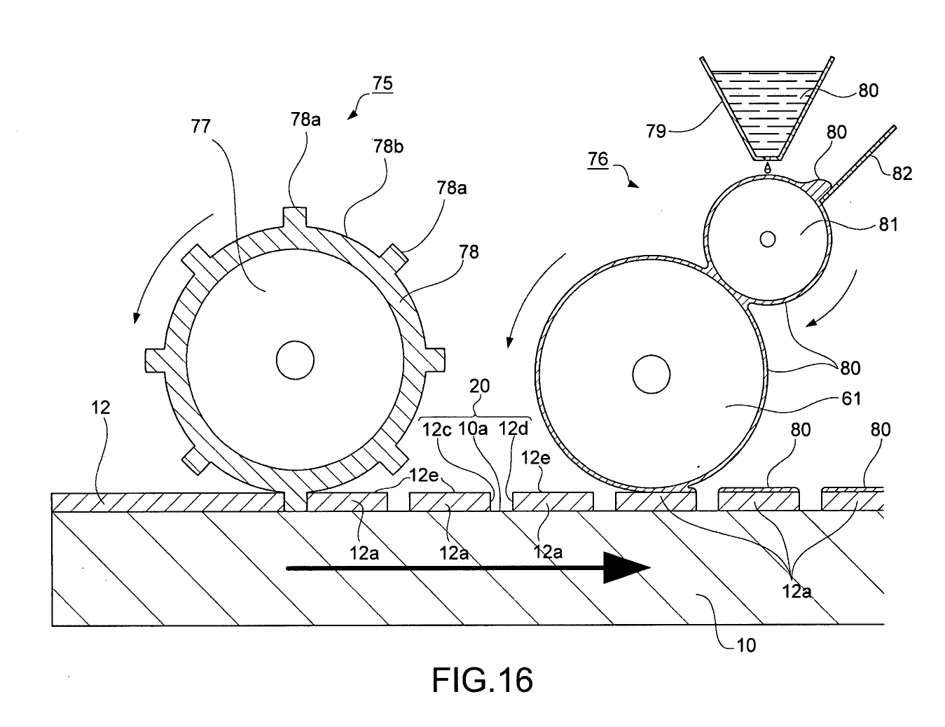

FIG. 16 is a sectional view of the substrate showing a process of applying the lyophobic agent 80 onto the bank upper face 12e of the necessary bank film 12a while forming the bank by the emboss printing method.

In FIG. 16, firstly, a film which becomes the bank film 12, for example, polymethylmethacrylate (PMMA) resin is formed on the substrate 10 as described above. Here, the bank film 12 may be sensitive or insensitive to light or heat. As the insensitive type one, there is a coating medium and the like.

The substrate 10 having the solidified bank film 12 is adequately pressed by an emboss printing device 75 and a lyophobic agent applying device 76, and a relative position is changed. The emboss printing device 75 has an aluminum plate 78 that has a tread pattern opposing the bank pattern around an emboss drum 77. If the aluminum plate 78 that dose not have the tread pattern opposing the bank pattern is used to fix the substrate with the emboss drum 77, the length (girth) of the aluminum plate 78 should be longer than the length of the direction in which the relative position of the substrate 10 is changed. In this way, the desired necessary bank film 12a can be obtained on the bank film 12 provided on the substrate 10.

In order to prevent the displacement by slipping when the relative position between the emboss drum 77 having the aluminum plate 78 and the substrate 10 having the bank film 12 is changed, a gear transfer mechanism or a belt transfer mechanism (not shown in the figures) is provided.

The tread pattern of the aluminum plate 78 opposing the predetermined bank pattern is formed by etching by the photolithography method or micro-melting process by laser. The depth of the tread pattern opposing the predetermined bank pattern is preferably equal to or deeper than the depth of the bank film 12.

When the substrate 10 having the solidified bank film 12 and the emboss printing device 75 are adequately pressed and the relative position is changed, a desired pattern which opposes the tread pattern of the aluminum plate 78 opposing the predetermined bank pattern is formed on the bank film 12.

The emboss printing device 75 leaves the necessary bank film 12a on the substrate 10 out of the bank film 12. The necessary bank film 12a is provided in a desired pattern on the substrate 10 through the above-mentioned process. A concave portion consists of the bank wall side face 12c of one necessary bank film 12a, the bank wall side face 12d of the other necessary bank film 12a opposing the necessary bank film 12a and the surface 10a of the substrate 10 is formed and this becomes the bank groove part 20. The upper face of the necessary bank film 12a is also called the bank upper face 12e in this embodiment. In this process, the bank film 12 can further obtain flexibility if bank film is heated, and the more appropriate necessary bank film 12a can be obtained.

The lyophobic agent applying device 76 has the rolled original plate member 61 which is other member than the substrate 10 in the second embodiment. The lyophobic agent 80 stored in a tank 79 is adequately supplied to a secondary roll 81. A film thickness control device 82 controls the thickness of the lyophobic agent 80 attached around the secondary roll 81.

The secondary roll 81 is placed adjacent to the original plate member 61, and the lyophobic agent 80 attached around the secondary roll 81 is transferred to the original plate member 61. The transferred lyophobic agent 80 is transferred to the bank upper face 12e by pressing the original plate member 61 to the bank upper face 12e of the necessary bank film 12a on the substrate 10. Following this, the above-mentioned film forming treatment of the lyophobic agent 80 is performed.

Through such process, the bank groove part 20 is formed on the bank film 12 provided on the substrate 10 by the emboss printing device 75, the lyophobic agent 80 is then applied to a part or whole of the bank upper face 12e by the lyophobic agent applying device 76, the film forming treatment is performed, and then the lyophobicity is given the bank upper face 12e.

Advantageous effect of this embodiment is now described.

(3) According to the embodiment, the bank groove part 20 is formed on the bank film 12 provided on the substrate 10 by the emboss printing device 75, and the lyophobic agent 80 is subsequently applied to a part or whole of the bank upper face 12e by the lyophobic agent applying device 76. Thereby, the productivity can be improved.

### Fourth Embodiment

Next, a fourth embodiment is described with reference to the figures.

Only different parts from those of the first embodiment will be described in this embodiment and parts that are not described are the same as those of the first embodiment.

In this embodiment, the invention is applied to a liquid crystal panel driven by thin film transistors (hereinafter called TFTs).

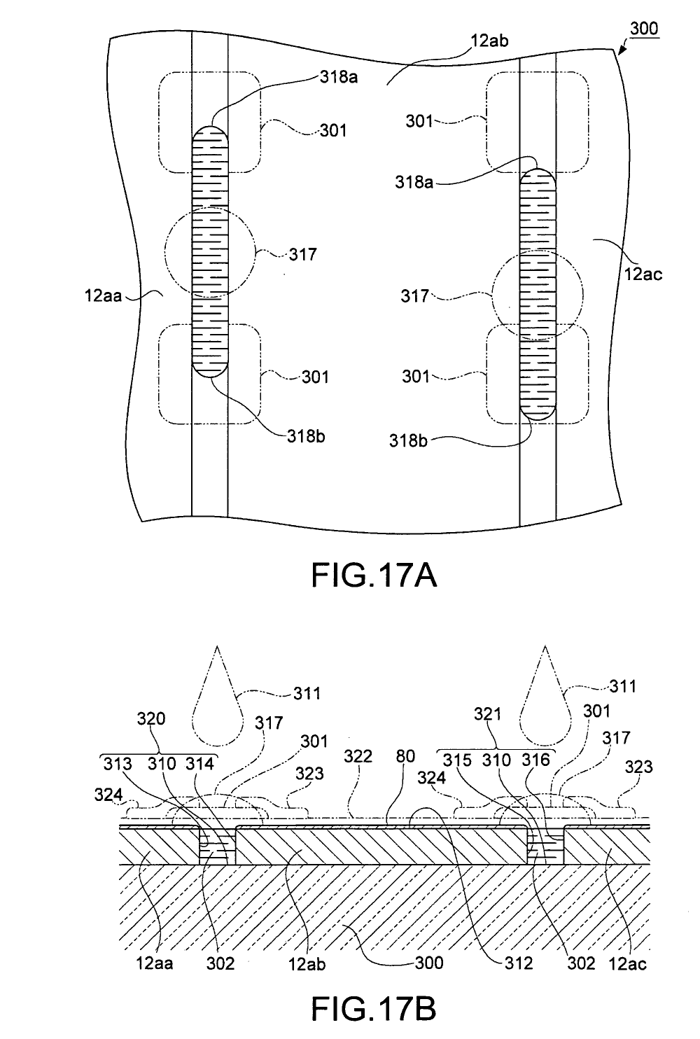

FIG. 17A is a partial plan view of the substrate showing a method of providing a gate electrode for mounting a TFT and FIG. 17B is a corresponding partial sectional view of the substrate.

A plurality of transparent pixel electrodes (not shown in the figures) is provided on a TFT array substrate 300 of the liquid crystal panel. Each pixel electrode has a semiconductor layer 301 made of a polysilicon film. Liquid crystal (not shown in the figures) is filled between the TFT array substrate 300 and an opposing substrate (not shown in the figures) that opposes the TFT array substrate 300. An alignment film (not shown in the figures) is provided on the surface of each substrate and the alignment treatment is performed to the film such that the liquid crystal is arranged in a predetermined direction. A pair of polarizing plates (not shown in the figures) whose polarization axis corresponds with the predetermined direction of the liquid crystal is provided in a light path.

This embodiment is described taking a case that a gate electrode 302 for the semiconductor layer 301 is formed.

Desired necessary bank films 12aa, 12ab, 12ac are formed on the TFT array substrate 300 in the way described above. A bank groove 320 is formed by a bank wall side face 313 of the necessary bank film 12aa, a bank wall side face 314 which is one side face of the necessary bank film 12ab and a TFT array substrate surface 310. Other bank groove 321 is formed by a bank wall side face 315 which is the other side face of the necessary bank film 12ab, a bank wall side face 316 which is one side face of the necessary bank film 12ac and the TFT array substrate surface 310. Though the bank grooves 320 and 321 are linear in this embodiment, they may be bent or deflexed. Moreover, the width of the bank grooves 320, 321 may not be constant.

The lyophobic agent 80 is subsequently applied to each bank upper face 312 of the necessary bank films 12aa, 12ab, 12ac and the film forming treatment is performed as described above. Accordingly, the bank upper face 312 shows the lyophobicity.

When a conductive liquid material 311 that is larger than the width of the bank grooves 320 and discharged from the above-described droplet discharge head 200 (see FIG. 13) reaches substantially the center of the bank groove 320 of the TFT array substrate 300, the conductive liquid material 311 is transformed into a conductive liquid material 317 and lands in the groove.

Since the size of the landed conductive liquid material 317 is larger than the width of the bank groove 320, a part of the conductive liquid material 317 lands on the bank upper face 312 of the necessary bank films 12aa and 12ab. However, according to the invention, all the conductive liquid material 317 landed on the bank upper face 312 is stored in the bank groove 320 because the lyophobic quality is given to the bank upper face 312 with the lyophobic agent 80 and the lyophilicity is given to the bank groove 320.

The stored conductive liquid material 317 is deformed in the bank groove 320 and spreads out to be a conductive liquid material 318a and a conductive liquid material 318b. How far the material spreads out depends on the width of the bank groove 320, the depth of the bank groove 320, the volume of the discharged conductive liquid material 311, the viscosity of the conductive liquid material 311, temperature of the TFT array substrate 300, a degree of the lyophilicity of the bank groove 320 and a degree of the lyophobicity of the bank upper face 312 by the lyophobic agent 80.

When the conductive liquid material 311 is discharged from the above-mentioned droplet discharge head 200 to other place on the bank groove 320, it should be discharged on the ground that how much the material spreads out as described above. In this case, if the conductive liquid material 311 is discharged so as to cover the area ranging from the conductive liquid material 318a to the conductive liquid material 318b, a thick gate electrode 302 can be obtained.

The gate electrode 302 may also be formed in the bank groove 321 by discharging the conductive liquid material 311 to it.

In the TFT array substrate 300, an insulating layer 322 is formed on a part or whole of the gate electrode 302 and the bank upper face 312 after the gate electrode 302 is formed. In this case, the insulating layer may be formed after the process of giving the lyophilicity to the lyophobic agent 80 provided on the bank upper face 312. The semiconductor layer 301 is formed on the insulating layer at a predetermined position. A source electrode 323 (see FIG. 17B) and a drain electrode 324 (see FIG. 17B) for the semiconductor layer 301 are also provided. In this way, the main parts of the TFT are formed.

Though this embodiment is described by taking the gate electrode 302 of the liquid crystal panel driven by TFT as an example, the embodiment of the invention can also be applied to electrodes of the other electrooptical devices. For example, the method of the invention can be applied to form other electrodes of the liquid crystal panel driven by TFT, electrodes of the liquid crystal panel driven by an organic TFT, electrodes of an organic electroluminescence display device and the like.

Advantageous effect of this embodiment is now described.

(4) Electrooptical devices are required to secure a large display area and increase the number of the pixels in order to realize high-resolution display. According to the above-described embodiment, it is possible to form electrodes controlling transistors and diodes as small in width as possible. At the same time, it is possible to form a reliable conductive pattern with which the conductive liquid material 311 dose not remain on the bank upper face 312.

The embodiments of the invention are not limited to the above description but can be modified as the following description.

### FIRST MODIFICATION EXAMPLE

Though the original plate surface 54a of the original plate member 51 that is the other member than the substrate 10 has a flat face in the above-described embodiment, a tread corresponding to the bank groove part 20 of the substrate 10 may be formed on the original plate surface 54a and the lyophobic agent 80 may be provided on a part or whole of the bank upper face 12e.

### SECOND MODIFICATION EXAMPLE

Though the stamp material 54 provided on the original plate member 61 that is the other member than the substrate 10 is in a form of the roll, a tread corresponding to the bank groove part 20 of the substrate 10 may be formed on the stamp material 54 and the lyophobic agent 80 may be provided on a part or whole of the bank upper face 12e.

What is claimed is:

1. A method of forming a conductive pattern, comprising:
forming a bank on a substrate; and
applying a lyophobic agent to a part or whole of an upper face of the bank.

2. A method of forming a conductive pattern, comprising:
forming a bank on a substrate;
giving a lyophilic quality to a part or whole of the substrate and the bank; and
applying a lyophobic agent to a part or whole of an upper face of the bank.

3. The method of forming a conductive pattern according to claim 1, wherein the lyophobic agent is attached to an original plate member that is separately provided other than the substrate, and the lyophobic agent is transferred to a part or whole of the upper face of the bank by contacting the original plate member with the upper face of the bank on the substrate.

4. The method of forming a conductive pattern according to claim 1, wherein the bank is formed by a photolithography method, a transfer method or a printing method.

5. The method of forming a conductive pattern according to claim 1, wherein the bank is made of an organic or inorganic material.

6. The method of forming a conductive pattern according to claim 1, wherein a height of the bank is equal to or more than 1 μm.

7. The method of forming a conductive pattern according to claim 2, wherein the process of giving the lyophilic quality to a part or whole of the substrate and the bank includes at least one of ozone oxidation treatment, plasma treatment, corona treatment, ultraviolet irradiation treatment, electron irradiation treatment, acid treatment and alkali treatment.

8. The method of forming a conductive pattern according to claim 3, wherein the original plate member is in a form of a plate or a roll.

9. The method of forming a conductive pattern according to claim 3, wherein a material for the original plate member is an elastomer having a siloxane structure.

10. The method of forming a conductive pattern according to claim 1, wherein the lyophobic agent is a silane coupling agent or a polymer having the lyophobic quality.
